(19) United States
(12) Patent Application Publication
(10) Pub. No.: US 2018/0105360 A1
(43) Pub. Date: Apr. 19, 2018

(54) METHODS, SYSTEMS, AND DEVICES RELATED TO STORAGE

(71) Applicant: Leif Tod Stordal, Newcastle, WA (US)

(72) Inventor: Leif Tod Stordal, Newcastle, WA (US)

(21) Appl. No.: 15/786,491

(22) Filed: Oct. 17, 2017

Related U.S. Application Data
(60) Provisional application No. 62/410,341, filed on Oct. 19, 2016.

(51) Int. Cl. B65G 1/04; H04W 84/18

(52) U.S. Cl. CPC B65G 1/04; H04W 84/18; B65G 2203/042; B65G 2203/0208; B65G 2201/02

(57) ABSTRACT

Methods, systems, and devices for storage are disclosed herein. More specifically, methods, systems, and devices that may be used to store numerous articles in a vertical space are disclosed and described.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC § 119(e) for provisional patent applications, for any and all parent, grandparent, great-grandparent, etc. applications of the Priority Application(s)). In addition, the present application is related to the “Related Applications,” if any, listed below.

### Priority Applications

Provisional Application 62/410,341 filed Oct. 19, 2016.

### Related Applications

None.

If the listings of applications provided above are inconsistent with the listings provided via an ADS, it is the intent of the Applicant to claim priority to each application that appears in the Priority Applications section of the ADS and to each application that appears in the Priority Applications section of this application.

If an Application Data Sheet (ADS) has been filed on the filing date of this application, it is incorporated by reference herein. Any applications claimed on the ADS for priority under 35 U.S.C. §§ 119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In some embodiments, a device includes, but is not limited to, a device comprising: at least one slider guide; at least one slider moveably coupled to the at least one slider guide; at least one yoke operably coupled to the at least one slider; at least one slider support operably coupled to the at least one slider; and at least one rotatable member operably coupled to the at least one slider support and the at least one slider guide.

In some embodiments, a device includes, but is not limited to, a device comprising: at least one slider guide; at least one slider moveably coupled to the at least one slider guide; at least one yoke operably coupled to the at least one slider; at least one slider support operably coupled to the at least one slider; and at least one winch operably coupled to the at least one slider support.

In some embodiments, a device includes, but is not limited to, a device comprising: at least one slider guide; at least one slider moveably coupled to the at least one slider guide; at least one yoke operably coupled to the at least one slider; at least one threaded member threadedly coupled to the at least one slider.

### BRIEF DESCRIPTION OF THE FIGURES

FIG. 1 illustrates a side view of an example system in which embodiments may be implemented.

FIG. 2 illustrates a side view of an example system in which embodiments may be implemented.

FIG. 3 illustrates a side view of an example system in which embodiments may be implemented.

FIG. 4 illustrates a side view of an example system in which embodiments may be implemented.

FIG. 5 illustrates a partial cross-sectional side view of an example system in which embodiments may be implemented.

FIG. 6 illustrates a partial cross-sectional side view of an example system in which embodiments may be implemented.

FIG. 7 illustrates a partial cross-sectional side view of an example system in which embodiments may be implemented.

FIG. 8 illustrates a partial cross-sectional side view of an example system in which embodiments may be implemented.

FIG. 9 illustrates a side view of an example system in which embodiments may be implemented.

FIG. 10 illustrates a side view of an example system in which embodiments may be implemented.

FIG. 11 illustrates a side view of an example system in which embodiments may be implemented.

FIG. 12 illustrates a side view of an example system in which embodiments may be implemented.

FIG. 13 illustrates a partial cross-sectional side view of an example system in which embodiments may be implemented.

FIG. 14 illustrates a partial cross-sectional side view of an example system in which embodiments may be implemented.

FIG. 15 illustrates a partial cross-sectional side view of an example system in which embodiments may be implemented.

FIG. 16 illustrates a partial cross-sectional side view of an example system in which embodiments may be implemented.

FIG. 17 illustrates a partial cross-sectional side view of an example system in which embodiments may be implemented.

FIG. 18 illustrates a side view of an example system in which embodiments may be implemented.

FIG. 19 illustrates a side view of an example system in which embodiments may be implemented.

FIG. 20 illustrates a side view of an example system in which embodiments may be implemented.

FIG. 21 illustrates a side view of an example system in which embodiments may be implemented.

FIG. 22 illustrates a partial cross-sectional side view of an example system in which embodiments may be implemented.

FIG. 23 illustrates a partial cross-sectional side view of an example system in which embodiments may be implemented.

FIG. 24 illustrates a partial cross-sectional side view of an example system in which embodiments may be implemented.

FIG. 25 illustrates a partial cross-sectional side view of an example system in which embodiments may be implemented.

FIG. 26 illustrates a side view of an example system in which embodiments may be implemented.

FIG. 27 illustrates a side view of an example system in which embodiments may be implemented.

FIG. 28 illustrates a side view of an example system in which embodiments may be implemented.

FIG. 29 illustrates a partial cross-sectional side view of an example system in which embodiments may be implemented.

FIG. 30 illustrates a partial cross-sectional side view of an example system in which embodiments may be implemented.

FIG. 31 illustrates a partial cross-sectional side view of an example system in which embodiments may be implemented.

FIG. 32 illustrates a front view of an example system in which embodiments may be implemented.

FIG. 33 illustrates a front view of an example system in which embodiments may be implemented.

FIG. 34 illustrates a front view of an example system in which embodiments may be implemented.

FIG. 35 illustrates a front view of an example system in which embodiments may be implemented.

FIG. 36 illustrates a front view of an example system in which embodiments may be implemented.

FIG. 37 illustrates a front view of an example system in which embodiments may be implemented.

FIG. 38 illustrates a rear view of an example system in which embodiments may be implemented.

FIG. 39 illustrates a front view of an example system in which embodiments may be implemented.

FIG. 40 illustrates a rear view of an example system in which embodiments may be implemented.

FIG. 41 illustrates a front view of an example system in which embodiments may be implemented.

FIG. 42 illustrates a side view of an example system in which embodiments may be implemented.

FIG. 43 illustrates a rear view of an example system in which embodiments may be implemented.

FIG. 44 illustrates a side view of an example system in which embodiments may be implemented.

FIG. 45 illustrates a side view of an example system in which embodiments may be implemented.

FIG. 46 illustrates a side view of an example system in which embodiments may be implemented.

FIG. 47 illustrates a cross-sectional transverse view of an example system in which embodiments may be implemented.

FIG. 48 illustrates a cross-sectional transverse view of an example system in which embodiments may be implemented.

FIG. 49 illustrates a partial cross-sectional side view of an example system in which embodiments may be implemented.

FIG. 50 illustrates a cross-sectional transverse view of an example system in which embodiments may be implemented.

FIG. 51 illustrates a partial cross-sectional side view of an example system in which embodiments may be implemented.

FIG. 52 illustrates a cross-sectional transverse view of an example system in which embodiments may be implemented.

FIG. 53 illustrates a partial cross-sectional side view of an example system in which embodiments may be implemented.

FIG. 54 illustrates a partial cross-sectional side view of an example system in which embodiments may be implemented.

FIG. 55 illustrates a partial cross-sectional side view of an example system in which embodiments may be implemented.

FIG. 56 illustrates a partial cross-sectional side view of an example system in which embodiments may be implemented.

FIG. 57 illustrates a cross-sectional transverse view of an example system in which embodiments may be implemented.

FIG. 58 illustrates a partial cross-sectional side view of an example system in which embodiments may be implemented.

FIG. 59 illustrates a partial cross-sectional side view of an example system in which embodiments may be implemented.

FIG. 60 illustrates a partial cross-sectional side view of an example system in which embodiments may be implemented.

FIG. 61 illustrates a partial cross-sectional side view of an example system in which embodiments may be implemented.

FIG. 62 illustrates a partial cross-sectional side view of an example system in which embodiments may be implemented.

FIG. 63 illustrates a partial cross-sectional side view of an example system in which embodiments may be implemented.

FIG. 64 illustrates a partial cross-sectional side view of an example system in which embodiments may be implemented.

FIG. 65 illustrates a side view of an example system in which embodiments may be implemented.

FIG. 66 illustrates a partial cross-sectional side view of an example system in which embodiments may be implemented.

FIG. 67 illustrates an example system diagram that may be implemented within system 100 and/or system 1000.

FIG. 68 illustrates an example operational flow chart that may be implemented within system 100 and/or system 1000.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

### System 100

System 100 may be configured in numerous ways. In some embodiments, system 100 may include slider 110. In some embodiments, slider 110 may be configured to be slideably coupled to slider guide 120. In some embodiments, slider 110 may be configured to encircle slider guide 120 and slide on the exterior of slider guide 120. In some embodiments, slider 110 may be configured to be contained within the interior of slider guide 120 and slide on the interior of slider guide 120. In some embodiments, slider 110 may be operably coupled to one or more tensioners 380. In some embodiments, slider 110 may be operably coupled to one or more retainer pins 200. In some embodiments, slider 110 may be operably coupled to one or more slider detainers 160. In some embodiments, slider 110 may be operably coupled to one or more cogs 260 that are configured to engage one or more teeth 270 positioned on slider guide 120. In some embodiments, teeth 270 may be operably coupled to the interior of slider guide 120. In some embodiments, teeth 270 may be operably coupled to the exterior of slider guide 120. In some embodiments, slider 110 may be operably coupled to one or more rollers 220. In some embodiments, slider 110 may be operably coupled to one or more bearings 340.

In some embodiments, slider 110 may be operably coupled to yoke 150. Yoke 150 may have numerous configurations. For example, in some embodiments, yoke 150 may be configured as a male coupler. In some embodiments, yoke 150 may be configured as a female coupler. In some embodiments, slider 110 may be removably coupled to yoke 150.

In some embodiments, system 100 may include one or more slider guides 120. In some embodiments, slider guide 120 may be tubular. In some embodiments, slider guide 120 may be tubular having two or more channels. In some embodiments, slider guide 120 may be tubular having a toothed track operably coupled to the interior of the tubular slider guide 120. In some embodiments, slider guide 120 may be solid stock.

In some embodiments, slider 110 may be operably coupled to slider support 130. In some embodiments, slider support 130 may be moveably coupled to one or more rotatable members 140. In some embodiments, slider support 130 may be operably coupled to weight 190. In some embodiments, slider support 130 may be operably coupled to spring 240. In some embodiments, slider support 130 may be operably coupled to winch 250. In some embodiments, slider support 130 may be positioned on the exterior of slider guide 120. In some embodiments, slider support 130 may be positioned on the interior of slider guide 120. In some embodiments, slider support 130 may be operably coupled to weight 190. In some embodiments, slider support 130 may be operably coupled to spring 240. In some embodiments, spring 240 may be positioned within the interior of slider guide 120. In some embodiments, spring 240 may be positioned on the exterior of slider guide 120.

In some embodiments, system 100 may include one or more weights 190. In some embodiments, system 100 may include one or more weights 190 that are positioned on the exterior of slider guide 120. In some embodiments, system 100 may include one or more weights 190 that are positioned within the interior of slider guide 120.

In some embodiments, system 100 may include one or more winches 250. In some embodiments, system 100 may include one or more winches 250 contained within the interior of slider guide 120. In some embodiments, system 100 may include one or more winches 250 positioned on the exterior of slider guide 120.

In some embodiments, system 100 may include one or more brackets 170. In some embodiments, one or more brackets 170 may be operably coupled to slider guide 120. In some embodiments, bracket 170 may be operably coupled to one or more fasteners 180. In some embodiments, slider guide 120 may include one or more retainer pin receivers 210.

In some embodiments, system 100 may include one or more hangers 280. In some embodiments, a hanger 280 may be permanently coupled to slider guide 120. In some embodiments, a hanger 280 may be moveably coupled to slider guide 120.

In some embodiments, system 100 may include one or more base plates 230. In some embodiments, a base plate 230 may be operably coupled to a single slider guide 120. In some embodiments, a base plate 230 may be operably coupled to two or more slider guides 120. In some embodiments, a base plate 230 may be operably coupled to one or more wheels 390.

In some embodiments, system 100 may include one or more stabilizers 300. In some embodiments, a stabilizer 300 may be operably coupled to two or more slider guides 120.

In some embodiments, system 100 may include one or more carriers 310. In some embodiments, a carrier 310 may be operably coupled to a slider 110. In some embodiments, a carrier 310 may be operably coupled to two or more sliders 110. In some embodiments, a carrier 310 may be configured to accept a wheel of a motorcycle 290. In some embodiments, a carrier 310 may be configured to accept two wheels of a motorcycle 290.

In some embodiments, system 100 may include one or more platforms 330. In some embodiments, a platform 330 may be operably coupled to a slider 110. In some embodiments, a platform 330 may be operably coupled to two or more sliders 110.

In some embodiments, system 100 may include one or more threaded members 370. In some embodiments, system 100 may include one or more threaded members 370 that are positioned within the interior of a tubular slider guide 120. In some embodiments, system 100 may include one or more threaded members 370 that are positioned on the exterior of slider guide 120. In some embodiments, a threaded member 370 may be operably coupled to a slider 110 such that rotation of the threaded member 370 will cause movement of the operably coupled slider 110 on the threaded member 370. In some embodiments, a threaded member 370 may be operably coupled to motor 360 such that operation of the motor 360 causes the operably coupled threaded member to rotate 370.

### Slider 110

System 100 includes at least one slider 110. The slider 110 may be operably coupled to slider guide 120. The slider 110 may be moveably coupled to slider guide 120. Accordingly, slider 110 may move in a manner that is guided by slider guide 120.

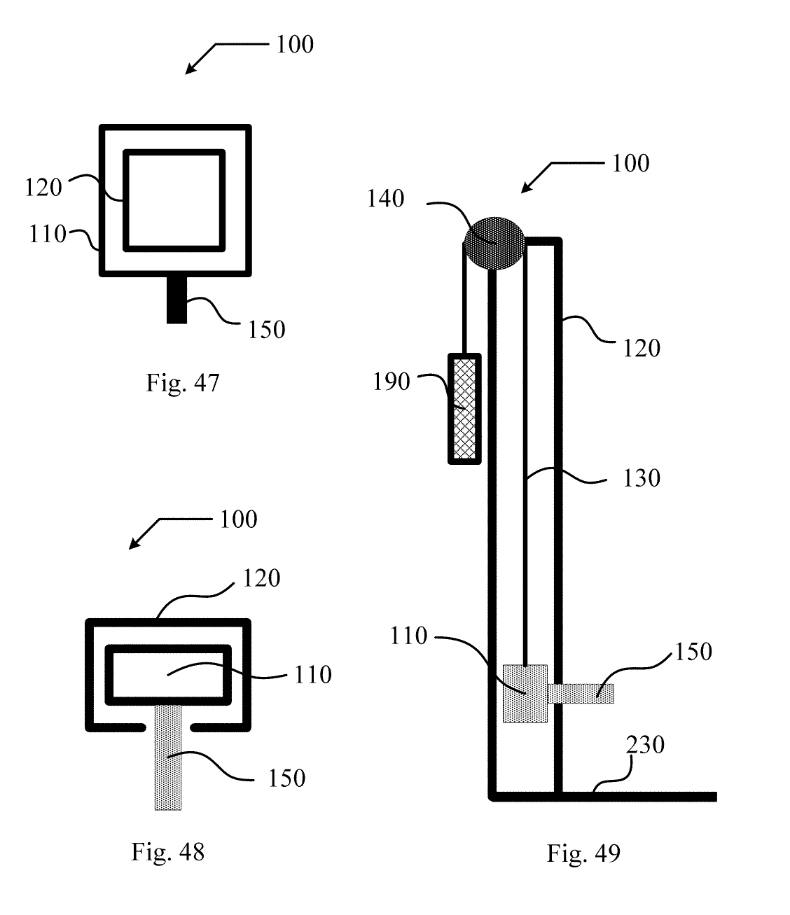

In some embodiments, slider 110 may be configured to be movably coupled to the exterior of slider guide 120 (see e.g., FIGS. 1-29, 32-47, and 65). For example, in some embodiments, a slider 110 may be tubular such that the slider guide 120 passes through the interior of the tubular slider 110 (see e.g., FIG. 47). Accordingly, a tubular slider 110 may be configured to have numerous geometries. In some embodiments, a slider 110 may be a tubular polygon. Examples of such polygons include, but are not limited to, a triangle, a rectangle (see e.g., FIG. 47), a pentagon, a hexagon, a heptagon, an octagon, a nonagon, a decagon, and the like.

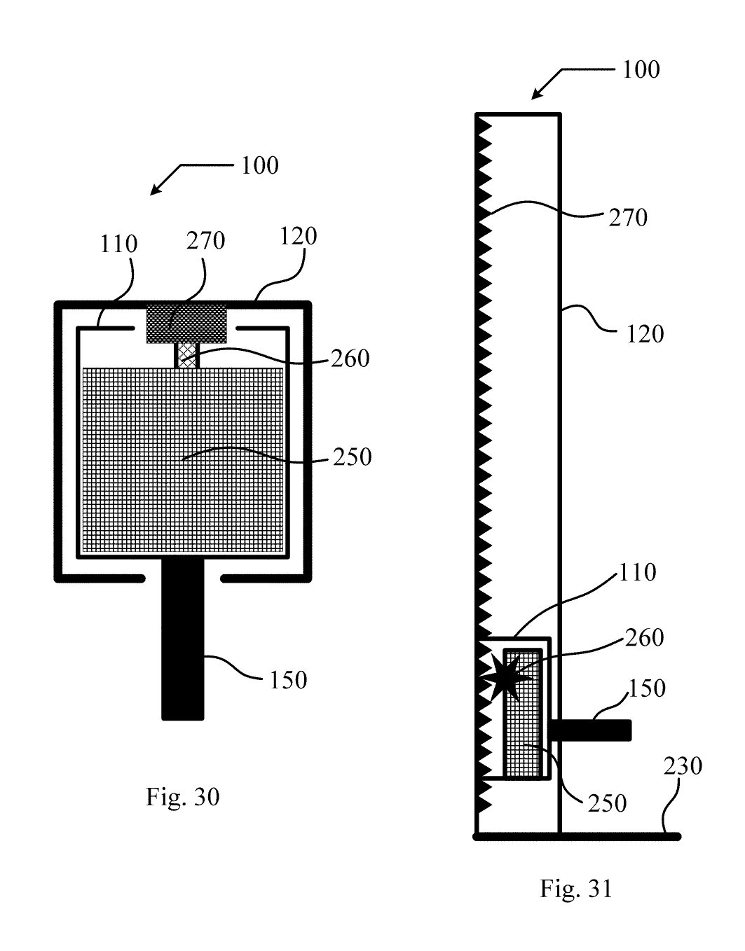

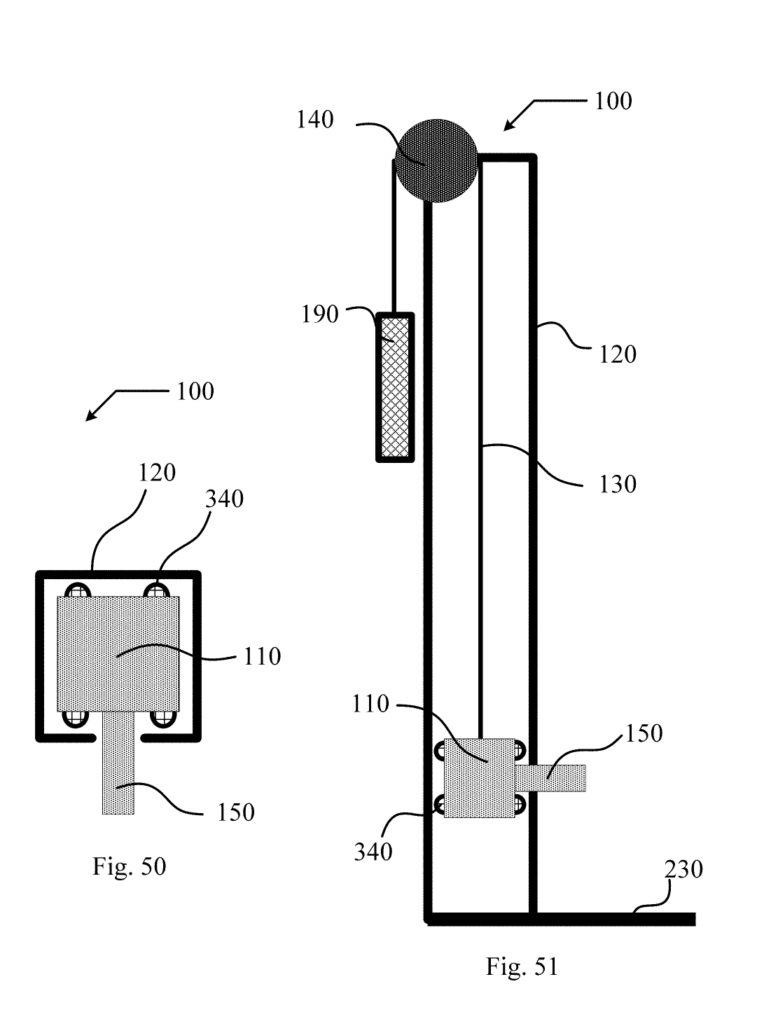

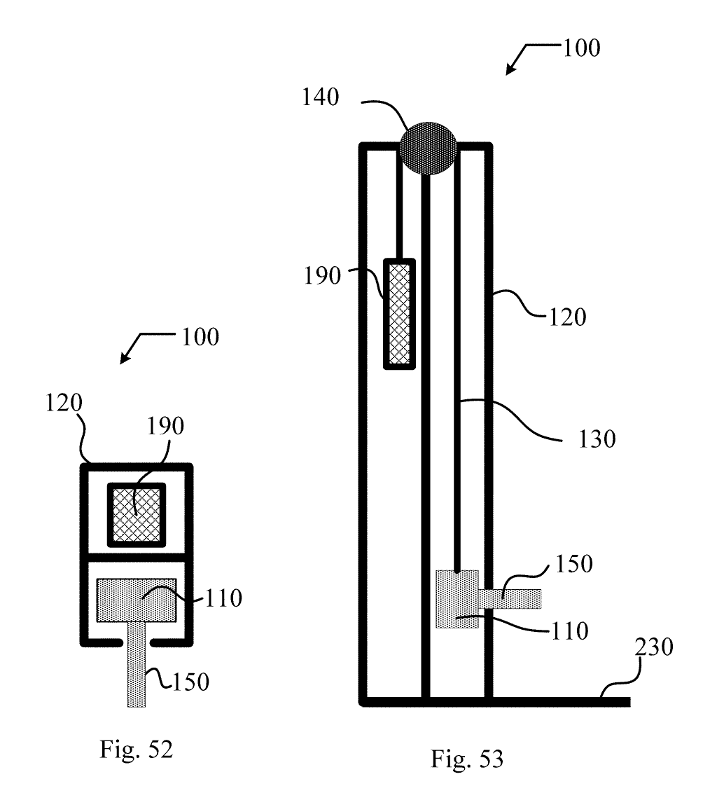

In some embodiments, slider 110 may be configured to be movably coupled within the interior of a tubular slider guide 120 (see e.g., FIGS. 30, 31, and 48-64). For example, in some embodiments, a slider 110 may pass within the interior of tubular slider guide 120 (see e.g., FIGS. 48, 50, and 52). Accordingly, a slider 110 configured to be movably coupled within the interior of a tubular slider guide 120 may have numerous geometries. In some embodiments, such a slider 110 may be a polygon. Examples of such polygons include, but are not limited to, a triangle, a rectangle (see e.g., FIGS. 48, 50, and 52), a pentagon, a hexagon, a heptagon, an octagon, a nonagon, a decagon, and the like. In some embodiments, slider 110 configured to be movably coupled within the interior of a tubular slider guide 120 may be solid (see e.g., FIGS. 50 and 52). In some embodiments, slider 110 configured to be movably coupled within the interior of a tubular slider guide 120 may be tubular (see e.g., FIG. 48).

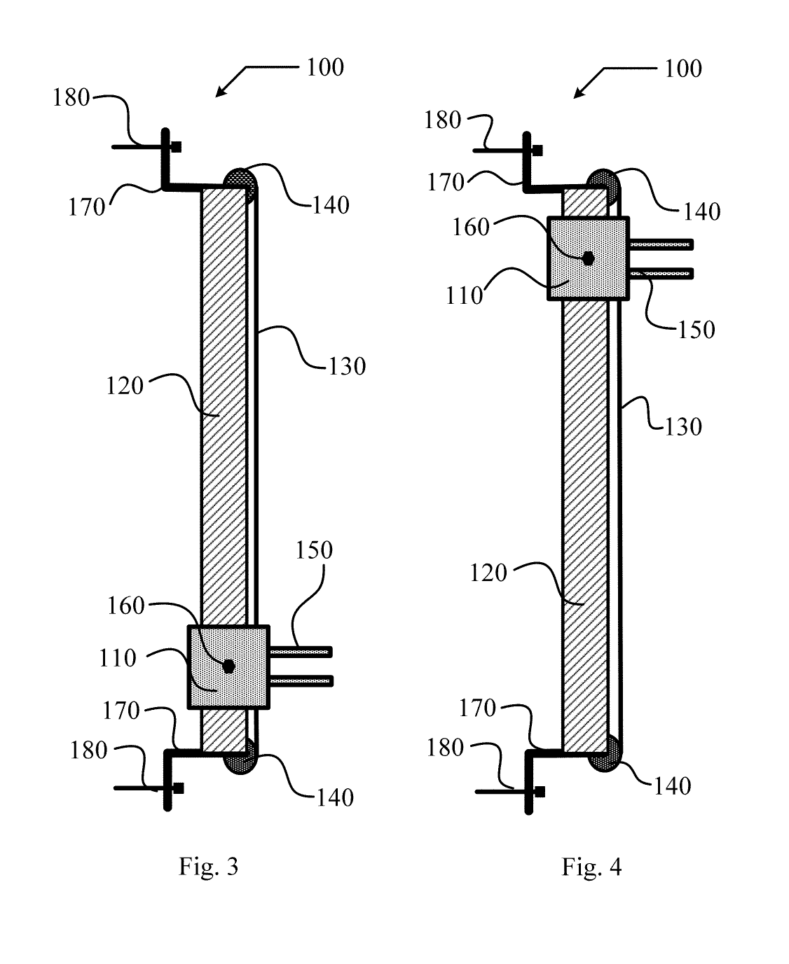

Slider 110 may be operably coupled to at least one yoke 150. In some embodiments, slider 110 may be removably coupled to yoke 150. In some embodiments, slider 110 may be permanently coupled to yoke 150. In some embodiments, slider 110 may be operably coupled to a male yoke 150 (see e.g., FIG. 1). In some embodiments, slider 110 may be operably coupled to a female yoke 150 (see e.g., FIG. 3). In some embodiments, a slider 110 that is configured to be operably coupled within the interior of a tubular slider guide 120 may be operably coupled to a yoke 150 that is configured to pass through a channel in the tubular slider guide 120 (see e.g., FIG. 48).

### Slider Guide 120

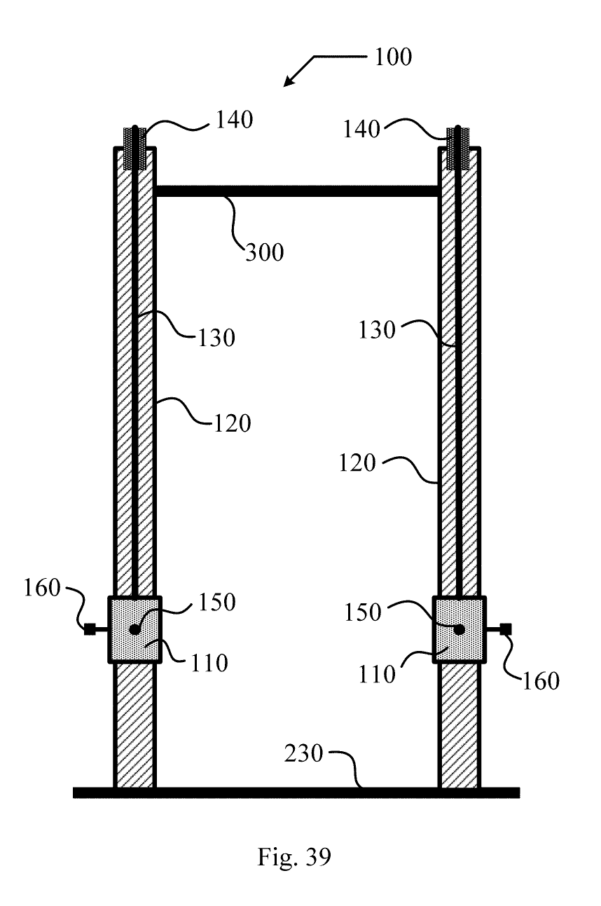

System 100 includes at least one slider guide 120. The slider guide 120 may be operably coupled to one or more sliders 110. For example, in some embodiments, a slider guide 120 may be operably coupled to one slider 110. In some embodiments, a slider guide 120 may be operably coupled to more than one slider 110 (e.g., two, three, four, and the like). The slider guide 120 may be moveably coupled to slider 110. Accordingly, slider guide 120 may guide movement of an operably coupled slider 110. In some embodiments, system 100 includes more than one slider guide 120 (e.g., two, three, four, and the like). In some embodiments, two or more slider guides 120 may be operably coupled to each other. In some embodiments, two or more slider guides 120 may be operably coupled to each other through a stabilizer 300 and/or a base plate 230 (see e.g., FIGS. 39-41).

In some embodiments, slider guide 120 may be configured to pass through the interior of a tubular slider 110 (see e.g., FIGS. 1-29, 32-47, and 65). Accordingly, a slider guide 120 may be configured to have numerous geometries. In some embodiments, a slider guide 120 may be a polygon. Examples of such polygons include, but are not limited to, a triangle, a rectangle (see e.g., FIG. 47), a pentagon, a hexagon, a heptagon, an octagon, a nonagon, a decagon, and the like.

In some embodiments, slider guide 120 may be tubular and configured to receive a slider 110 within the interior of the tubular slider guide 120 (see e.g., FIGS. 30, 31, and 48-64). Accordingly, in some embodiments, a tubular slider guide 120 may guide movement of a slider 110 within the interior of the tubular slider guide 120. Accordingly, a tubular slider guide 120 configured to receive a slider 110 within the interior of the tubular slider guide 120 may have numerous geometries. In some embodiments, such a tubular slider guide 120 may be a polygon. Examples of such polygons include, but are not limited to, a triangle, a rectangle (see e.g., FIGS. 48, 50, and 52), a pentagon, a hexagon, a heptagon, an octagon, a nonagon, a decagon, and the like.

In some embodiments, a slider guide 120 may be tubular. In some embodiments, a slider guide 120 may be solid (e.g., a solid rod). In some embodiments, a slider guide 120 may be substantially solid (e.g., a rod having holes there through).

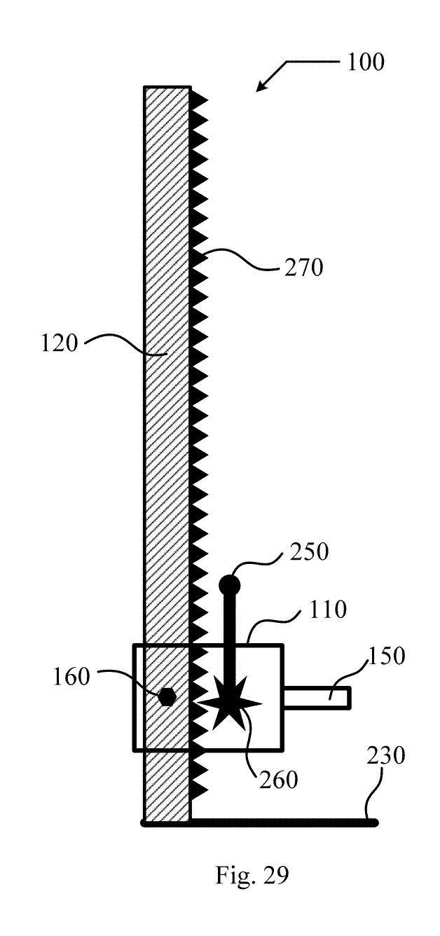

In some embodiments, a tubular slider guide 120 may include one or more channels through which a yolk 150 that is operably coupled to a slider 110 contained within the tubular slider guide 120 may pass (see e.g., FIG. 48). In some embodiments, a slider guide 120 may include a toothed track (see e.g., FIGS. 29-31). In some embodiments, a tubular or non-tubular slider guide 120 may include a toothed track that is positioned on the exterior of the slider guide 120 (see e.g., FIG. 29). In some embodiments, a tubular slider guide 120 may include a toothed track that is positioned on the interior of the tubular slider guide 120 (see e.g., FIGS. 30 and 31).

### Slider Support 130

System 100, in some embodiments, may include at least one slider support 130. In some embodiments, system 100 may include more than one slider support 130 (e.g., two, three, four, and the like). A slider support 130 may be operably coupled to one or more sliders 110. For example, in some embodiments, a slider support 130 may be operably coupled to one slider 110. In some embodiments, a slider support 130 may be operably coupled to more than one slider 110 (e.g., two, three, four, and the like). In some embodiments, the slider support 130 may be removably coupled to slider 110. In some embodiments, the slider support 130 may be permanently coupled to slider 110.

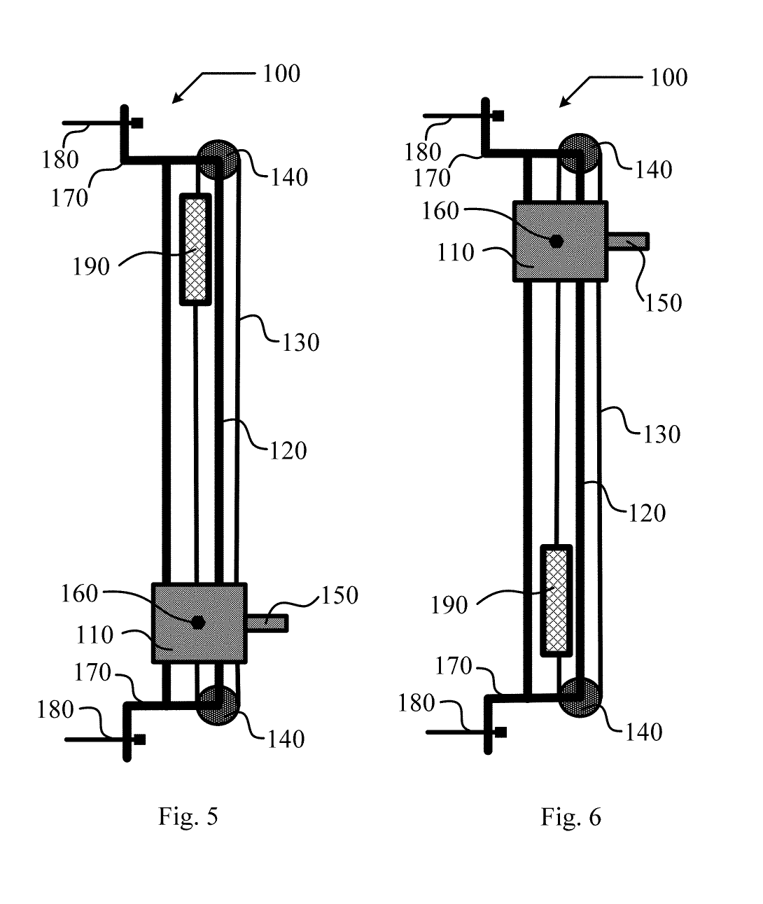

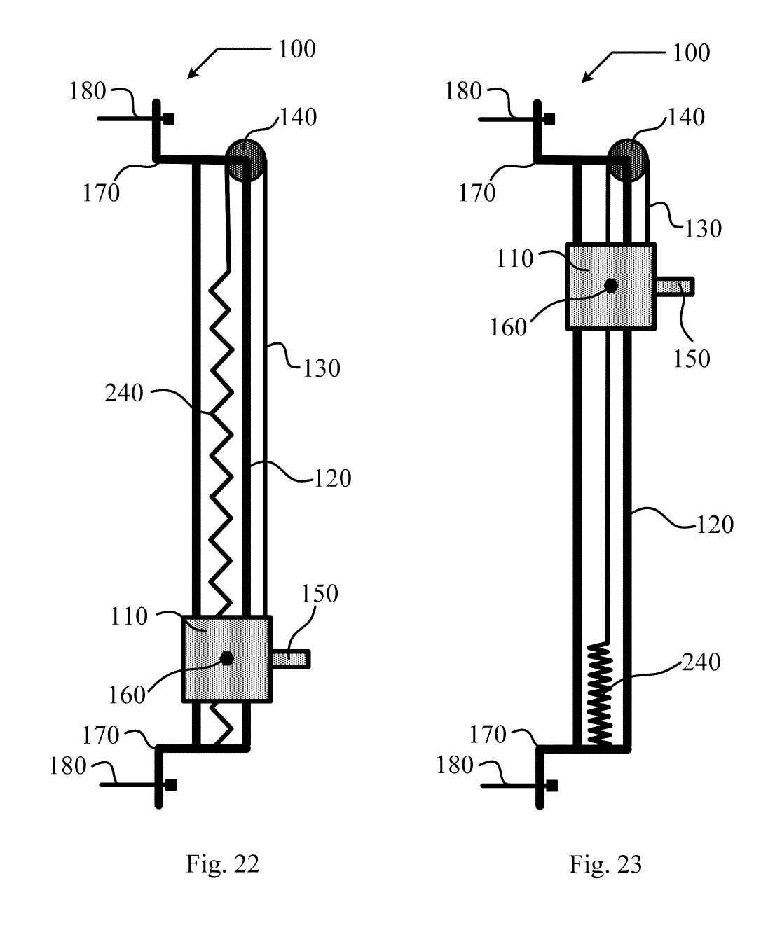

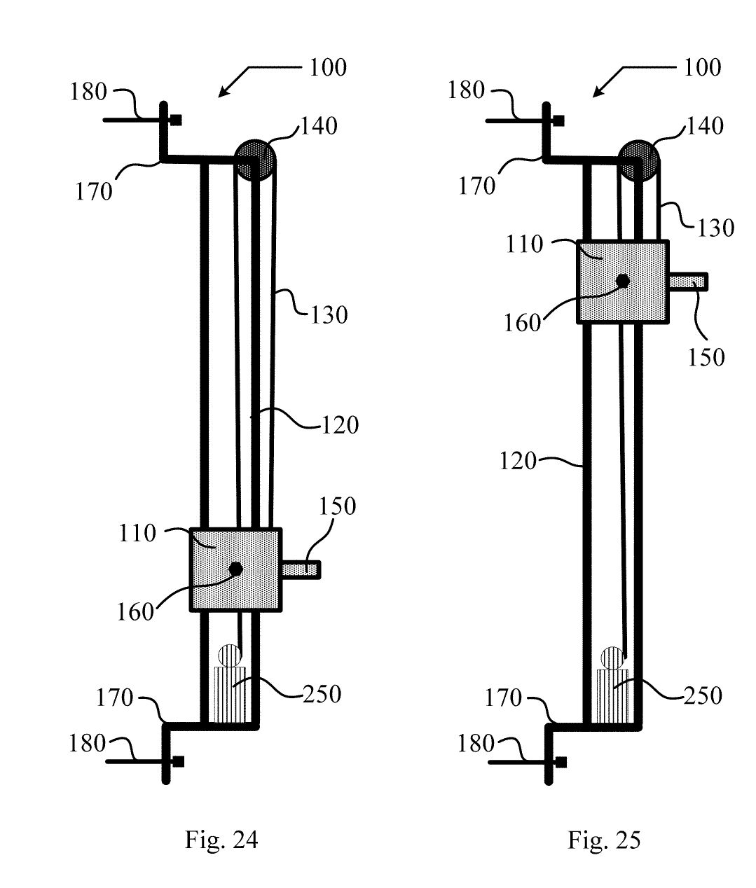

Generally, a slider support 130 is configured to operably couple a slider 110 to a member that confers or assists in conferring movement to the slider 110. For example, in some embodiments, a slider support 130 may couple a slider 110 to a weight 190 (see e.g., FIG. 5). In some embodiments, a slider support 130 may couple a slider 110 to a rotatable member 140 (see e.g., FIG. 5). In some embodiments, a slider support 130 may couple a slider 110 to a spring 240 (see e.g., FIGS. 22 and 23). In some embodiments, a slider support 130 may couple a slider 110 to a winch 250 (see e.g., FIGS. 24-28). In some embodiments, a slider support 130 may couple a slider 110 to a rotatable member 140 and to a weight 190, a winch 250, a spring 240, and/or a combination thereof (see e.g., FIGS. 5, 22, 23, 24-28).

Accordingly, a slider support 130 may have numerous configurations. In some embodiments, a slider support 130 may be constructed from a flexible material. For example, in some embodiments, a slider support 130 may be a cable. In some embodiments, a slider support 130 may be a chain. In some embodiments, a slider support 130 may be a belt (e.g., a v-belt, a toothed belt). In some embodiments, a slider support 130 may be a rope.

### Rotatable Member 140

System 100, in some embodiments, may include one or more rotatable members 140. In some embodiments, system 100 may include one rotatable member 140. In some embodiments, system 100 may include more than one rotatable member 140 (e.g., two, three, four, and the like). In some embodiments, system 100 may not include a rotatable member 140.

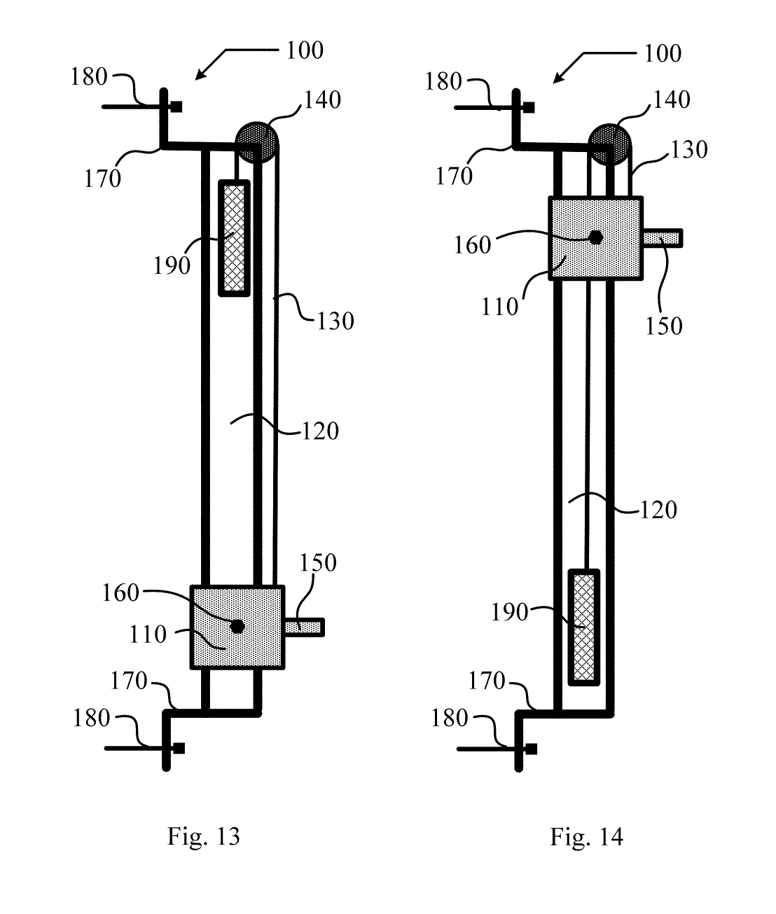

In some embodiments, a rotatable member 140 is configured to assist in facilitating movement of one or more sliders 110. For example, in some embodiments, a rotatable member 140 that is configured as a pulley may assist in the movement of a slider 110 that is operably coupled to a slider support 130 that is operably coupled to a weight 190, a winch 250, a spring 240, and the like (see e.g., FIGS. 13, 14, 24, 25, and 26). Accordingly, a rotatable member 140 may be configured in numerous ways. Examples of such rotatable members 140 include, but are not limited to, a pulley, a cog 260, a sprocket, a gear, and the like.

In some embodiments, a rotatable member 140 may be operably coupled to one or more tensioners 380. Examples, of tensioners 380 that may be operably coupled to a rotatable member 140 include, but are not limited to, a friction plate, a drum brake, a compression plate, and the like. Accordingly, in some embodiments, the freedom with which a rotatable member 140 may rotate may be adjusted.

In some embodiments, a rotatable member 140 may be operably coupled to a slider guide 120 (see e.g., FIGS. 13 and 14). In some embodiments, multiple rotatable members 140 may be operably coupled to a slider guide 120 (see e.g., FIGS. 1, 2, 32, and 33).

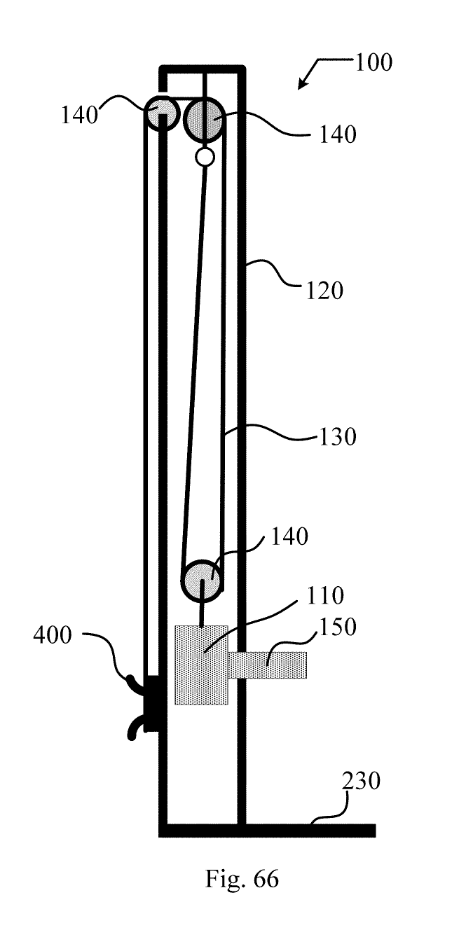

In some embodiments, two or more rotatable members 140 may be used to provide a mechanical advantage with regard to movement of slider 110. For example, in some embodiments, two or more rotatable members 140 may be configured as a block and tackle system in conjunction with a slider support 130 (see e.g., FIG. 66). Examples of such block and tackle systems include, but are not limited to, a gun tackle, a luff tackle, a double tackle, a gyn tackle, a threefold purchase, and the like.

### Yoke 150

System 100 may include one or more yokes 150. For example, in some embodiments, system 100 may include one yoke 150. In some embodiments, system 100 may include more than one yoke 150 (e.g., two, three, four, and the like).

In some embodiments, a yoke 150 may be operably coupled to a slider 110. In some embodiments, a yoke 150 may be removably coupled to a slider 110. For example, in some embodiments, a yoke 150 may be screwed into a threaded hole included within a slider 110. In some embodiments, a yoke 150 may be permanently coupled to a slider 110. Accordingly, in some embodiments, a yoke 150 may be moved in conjunction with movement of a slider 110 to which the yoke 150 is operably coupled. In some embodiments, a second article (e.g., a bike rack, a motorcycle, a carrier, and the like) that is operably coupled to a yoke 150 may be moved in conjunction with movement of a slider 110 to which the second article is coupled.

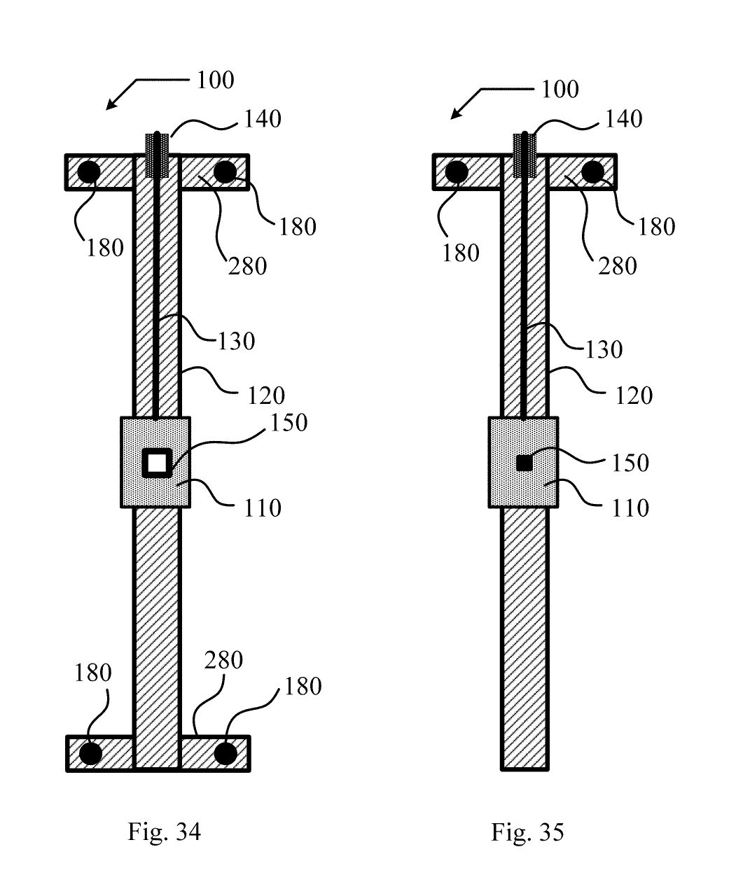

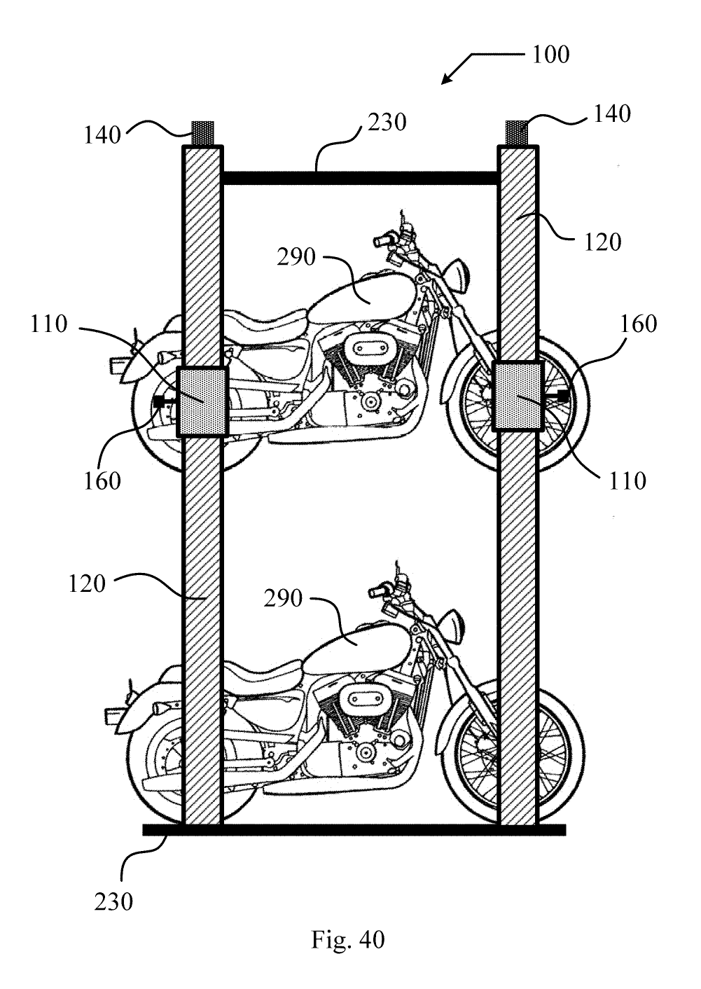

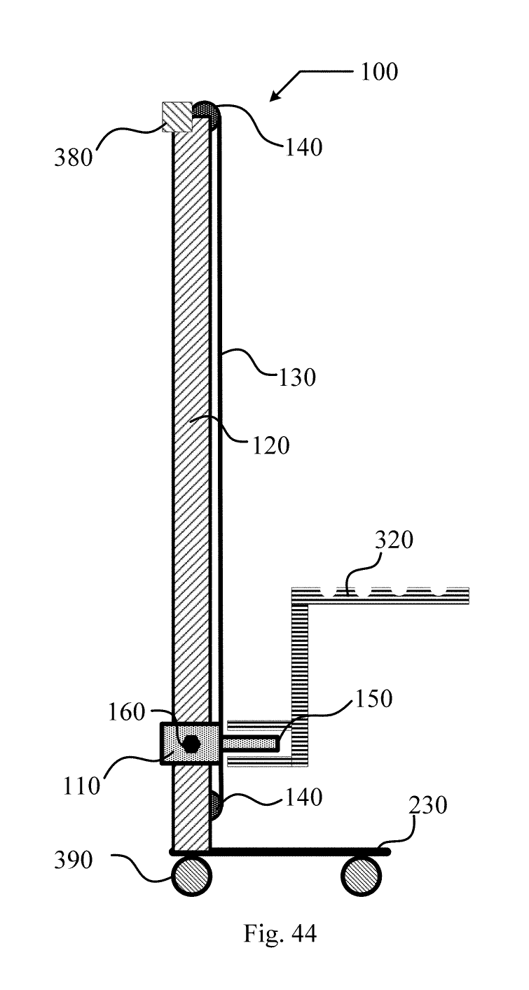

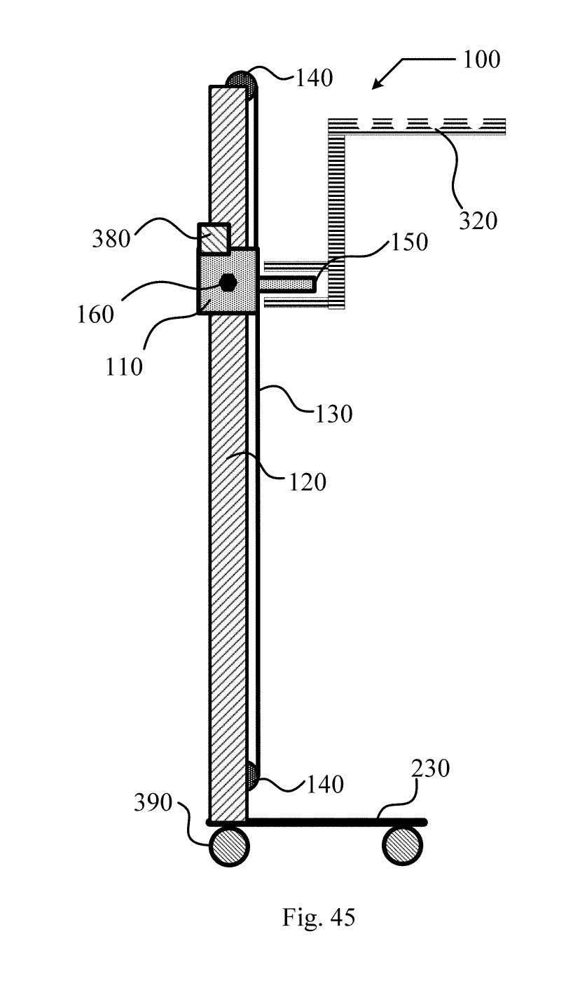

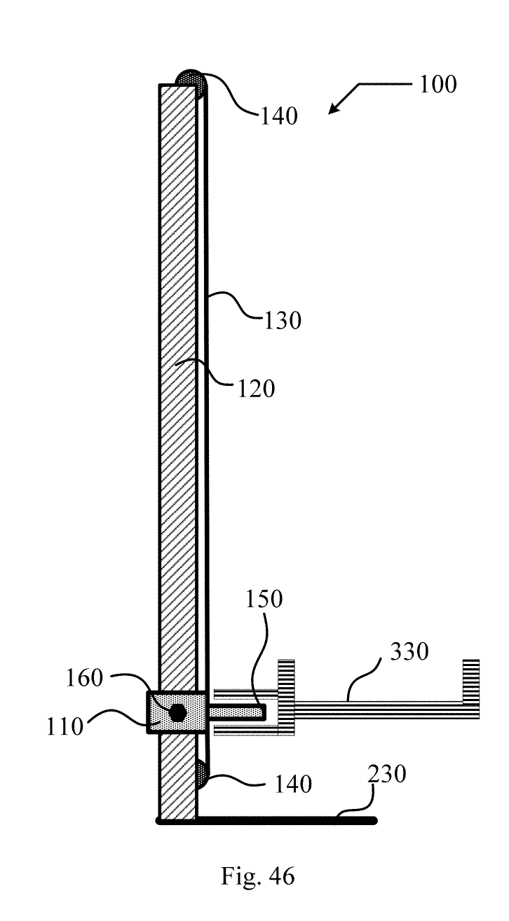

A yoke 150 may be configured in numerous ways. In some embodiments, a yoke 150 may be configured as a female yoke 150 configured to receive an article (see e.g., FIGS. 34, 36, and 42). For example, in some embodiments, a female yoke 150 may be configured as a receiver similar to those found on a trailer hitch that is configured to receive a coupling member of a detachable bike rack 320. Accordingly, in some embodiments, a detachable bike rack 320 may be removably coupled to a female yoke 150. In some embodiments, a carrier may be removably coupled to a female yoke 150 (see e.g., FIG. 42). In some embodiments, such a carrier may be configured to support a motorcycle 290. In some embodiments, a yoke 150 may be configured as a male yoke 150 which may be inserted into a receiving member of an article (see e.g., FIGS. 35 and 46). For example, in some embodiments, a yoke 150 may be configured to be inserted into a receiving member of a detachable bike rack 320 (see e.g., FIGS. 44 and 45). Accordingly, in some embodiments, a male yoke 150 may be specifically configured to couple system 100 to a bike rack 320. In some embodiments, a yoke 150 may be configured as a male yoke 150 that is configured to be inserted into a hub on the wheel of a motorcycle 290 (see e.g., FIGS. 39 and 40). In some embodiments, a carrier 310 may be removably coupled to a yoke 150. In some embodiments, such a carrier 310 may be configured to support a motorcycle 290.

### Slider Detainer 160

System 100 may optionally include one or more slider detainers 160. In some embodiments, system 100 may not include a slider detainer 160. In some embodiments, system 100 may include more than one slider detainers 160 (e.g., two, three, four, and the like).

A slider detainer 160 may be configured to detain a slider 110 to which the slider detainer 160 is operably coupled at a position on a slider guide 120. Accordingly, a slider detainer 160 may be configured in numerous ways. For example, in some embodiments, a slider detainer 160 may be configured as a retainer pin 200 that is configured to be inserted into a retainer pin receiver 210 on a slider guide 120. In some embodiments, such a retainer pin receiver 210 may be a hole positioned in the slider guide 120 that is configured to receive a retainer pin 200. In some embodiments, such a retainer pin receiver 210 may be an indentation positioned in the slider guide 120 that is configured to receive a retainer pin 200. In some embodiments, such retainer pin 200 may be operably coupled to a spring that urges the retainer pin 200 into the retainer pin receiver 210. In some embodiments, a slider detainer 160 may be configured as a friction member. For example, in some embodiments, a slider detainer 160 may be include a screw that is operably coupled to a friction member such that turning the screw will force the friction member against a slider guide 120 and detain the operably coupled slider 110 at a position on the slider guide 120.

### Bracket 170

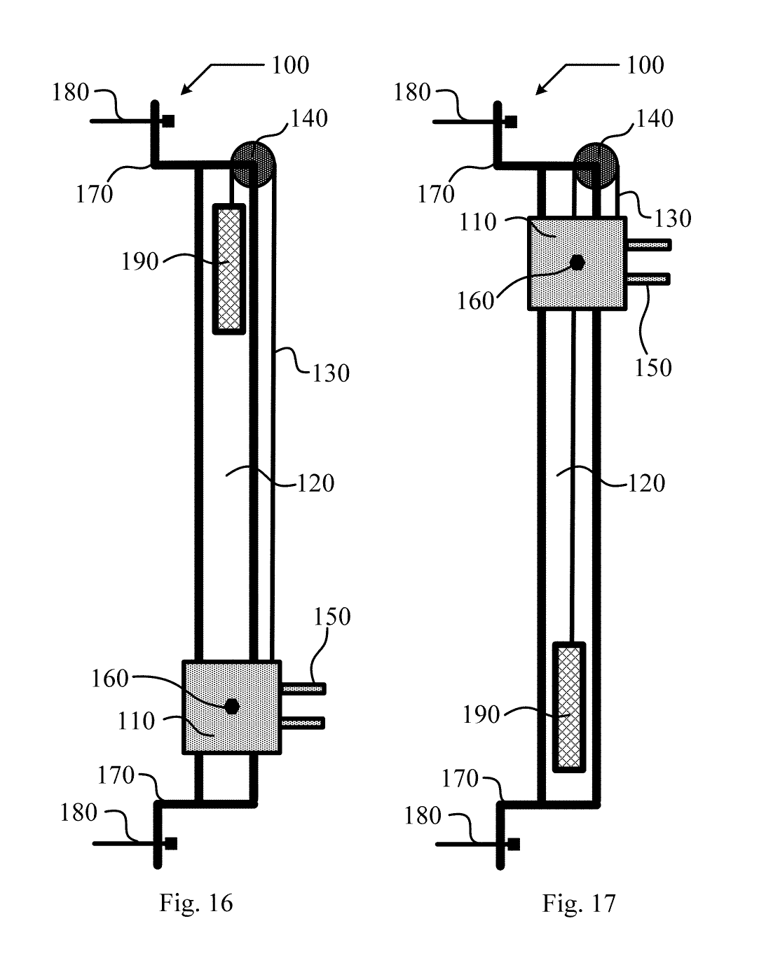

System 100, in some embodiments, may include one or more brackets 170. For example, in some embodiments, system 100 may include one bracket 170. In some embodiments, system 100 may include more than one brackets 170 (e.g., two, three, four, and the like) (see e.g., FIG. 16). In some embodiments, system 100 may not include a bracket 170 (see e.g., FIG. 19).

In some embodiments, system 100 may include one or more brackets 170 configured to provide for attachment of system to a substantially vertical structure. For example, in some embodiments, one or more brackets 170 may provide for attachment of system to a wall. In some embodiments, system 100 may include one or more brackets 170 and one or more base plates 230. Accordingly, in some embodiments, system 100 may be supported on a horizontal surface as well as a vertical surface.

In some embodiments, one or more fasteners 180 may be used in association with one or more brackets 170 to secure system 100 to a surface. Numerous types of fasteners 180 may be used. Examples of such fasteners 180 include, but are not limited to, screws, bolts, nuts, nails, drywall anchors, and the like.

### Weight 190

System 100, in some embodiments, may include one or more weights 190. For example, in some embodiments, system 100 may include one weight 190. In some embodiments, system 100 may include more than one weight 190 (e.g., two, three, four, and the like). In some embodiments, system 100 may not include a weight 190.

In some embodiments, weight 190 may be used to counterbalance slider 110. In some embodiments, weight 190 may be used to counterbalance slider 110 and a load coupled to the slider 110. For example, in some embodiments, one or more weights 190 may be used to counterbalance a bike rack 320 that is operably coupled to slider 110.

### Roller 220

System 100, in some embodiments, may include one or more rollers 220. For example, in some embodiments, system 100 may include one roller 220. In some embodiments, system 100 may include more than one roller 220 (e.g., two, three, four, and the like). In some embodiments, system 100 may not include a roller 220.

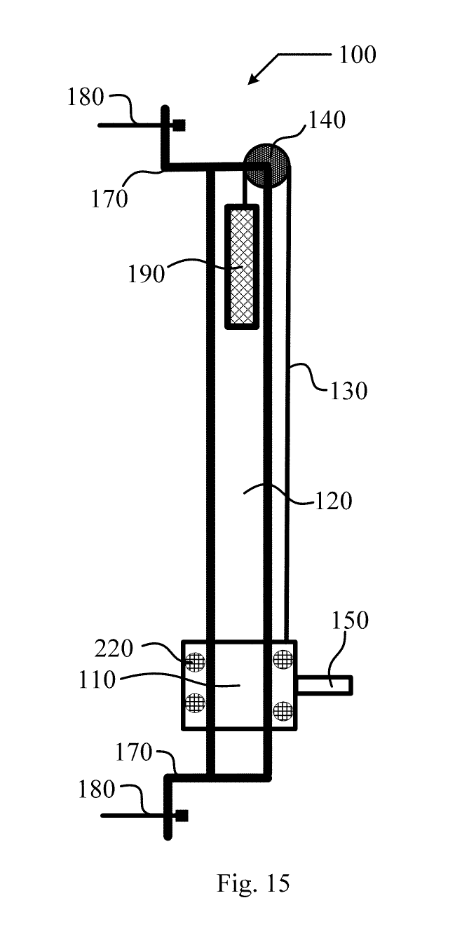

One or more rollers 220 may be operably coupled to a slider 110 (see e.g., FIG. 15). In some embodiments, a roller 220 may be operably coupled to an interior surface of a tubular slider 110 and configured to assist movement of the slider 110 on a slider guide 120. In some embodiments, a roller 220 may be configured to align a tubular slider 110 on a slider guide 120.

### Base Plate 230

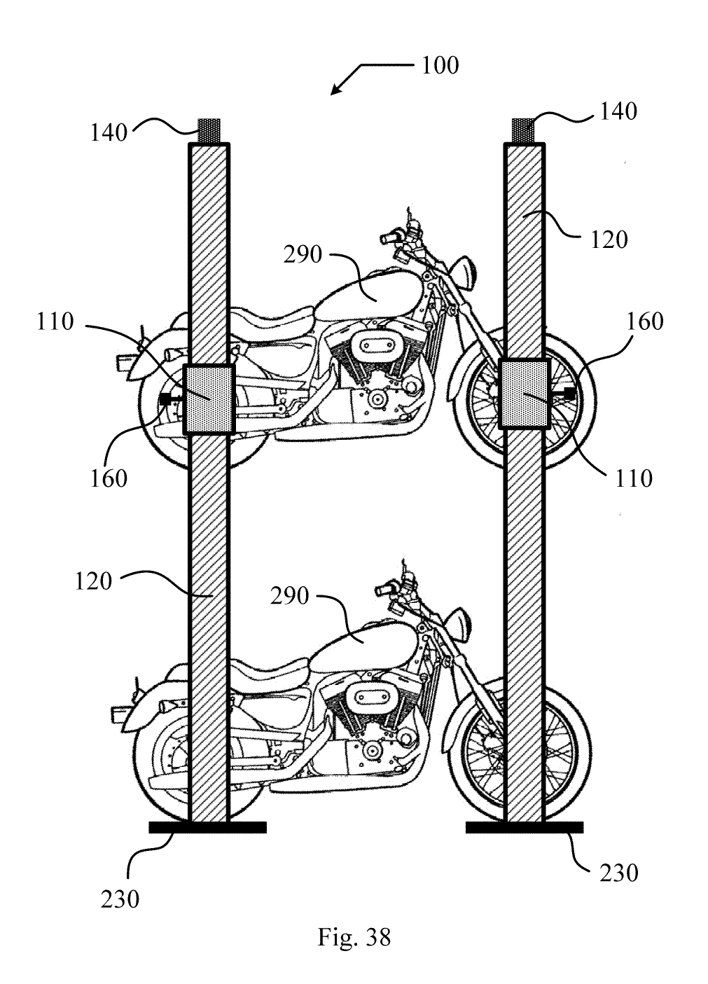

System 100, in some embodiments, may include one or more base plates 230. For example, in some embodiments, system 100 may include one base plate 230 (see e.g., FIG. 28). In some embodiments, system 100 may include more than one base plates 230 (e.g., two, three, four, and the like) (see e.g., FIG. 38). In some embodiments, system 100 may not include a base plate 230 (see e.g., FIG. 15).

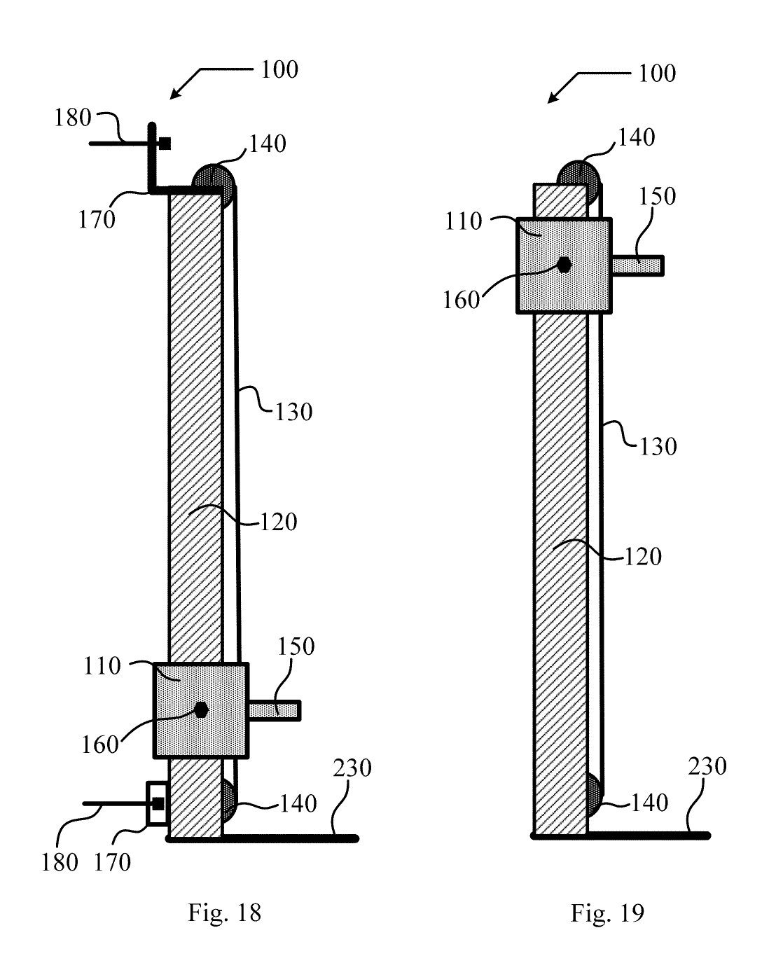

In some embodiments, a base plate 230 may be operably coupled to a slider guide 120. In some embodiments, a base plate 230 may be configured to stabilize the slider guide 120 and allow the slider guide 120 to be supported in a vertical position independently of attachment to a surface. In some embodiments, a base plate 230 may be operably coupled to a single slider guide 120 (see e.g., FIG. 18). In some embodiments, a base plate 230 may be operably coupled to more than one slider guide 120 (see e.g., FIG. 39).

In some embodiments, a base plate 230 may be operably coupled to one or more wheels 390 (see e.g., FIGS. 44 and 45). In some embodiments, such wheels 390 may be casters.

### Spring 240

System 100, in some embodiments, may include one or more springs 240. For example, in some embodiments, system 100 may include one spring 240 (see e.g., FIGS. 22 and 23). In some embodiments, system 100 may include more than one spring 240 (e.g., two, three, four, and the like). In some embodiments, system 100 may not include a spring 240.

In some embodiments, a spring 240 may be operaby coupled to a slider support 130. Accordingly, in some embodiments, a spring 240 may serve to provide locomotive force to a slider 110. In some embodiments, a spring 240 may serve to provide locomotive force to a slider 110 and a load that is coupled to the slider 110.

### Winch 250

System 100, in some embodiments, may include one or more winches 250. For example, in some embodiments, system 100 may include one winch 250 (see e.g., FIGS. 26-31, 56-62). In some embodiments, system 100 may include more than one winch 250 (e.g., two, three, four, and the like). In some embodiments, system 100 may not include a winch 250.

In some embodiments, a winch 250 may be operaby coupled to a slider support 130. Accordingly, in some embodiments, a winch 250 may serve to provide locomotive force to a slider 110. In some embodiments, a winch 250 may serve to provide locomotive force to a slider 110 and a load that is coupled to the slider 110.

In some embodiments, a winch 250 may be an electric winch 250. Accordingly, in such embodiments, an electrical control system may be coupled to the winch 250 to control operation of the electric winch 250. In some embodiments, a winch 250 may be a manual winch 250. Accordingly, in such embodiments, the winch 250 may be manually operated by a user.

In some embodiments, a winch 250 may include one or more cogs 260 that are configured to engage a toothed 270 track that is operaby coupled to a slider guide 120 (see e.g., FIGS. 29 and 30. In some embodiments, such a winch 250 may be operably coupled to a slider 110 (see e.g., FIGS. 29 and 30). In some embodiments, such a winch 250 may be a manual winch 250 such that turning a crank that is operably coupled to a cog 260 will cause movement of the operably coupled slider 110 on the slider guide 120 through engagement with a toothed 270 track (see e.g., FIG. 29). In some embodiments, such a winch 250 may be an electric winch 250 such that operating an electric motor 360 that is operably coupled to the cog 260 will cause movement of the operably coupled slider 110 on the slider guide 120 through engagement with a toothed 270 track (see e.g., FIG. 30).

### Hanger 280

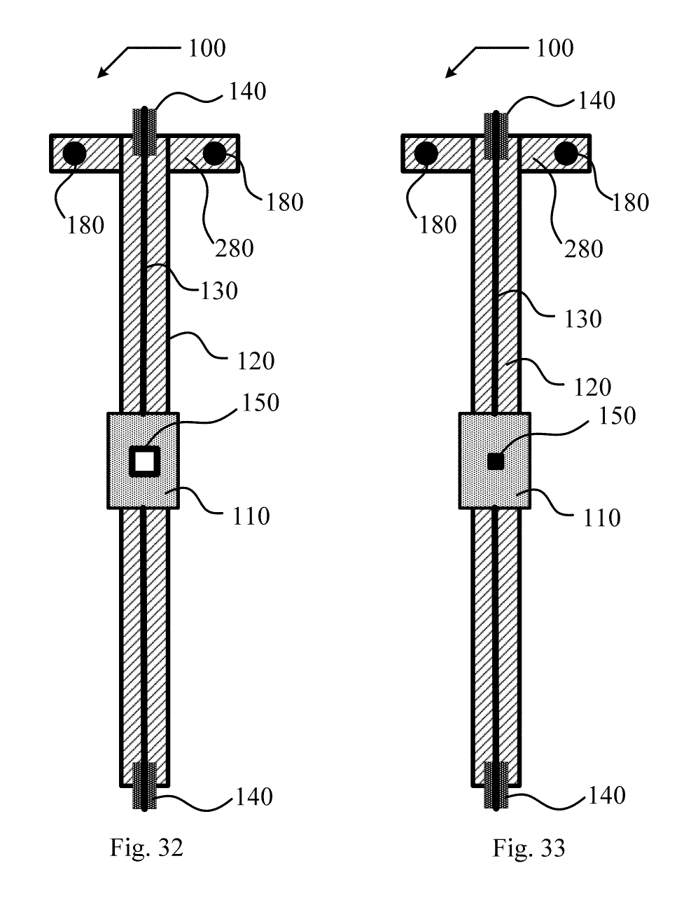

System 100, in some embodiments, may include one or more hangers 280. For example, in some embodiments, system 100 may include one hanger 280 (see e.g., FIGS. 32, 33, and 35). In some embodiments, system 100 may include more than one hanger 280 (e.g., two, three, four, and the like) (see e.g., FIG. 34). In some embodiments, system 100 may not include a hanger 280. In some embodiments, a slider guide 120 may be operably coupled to one or more hangers 280. In some embodiments, a hanger 280 may be operably coupled to one or more slider guides 120.

In some embodiments, hanger 280may be configured for attachment to a surface. For example, in some embodiments, a hanger 280 may be configured to attachment to a wall. Accordingly, in some embodiments, a hanger 280 may allow a slider guide 120 to be attached to a surface, such as a wall.

In some embodiments, a slider guide 120 may be permanently coupled to a hanger 280. In some embodiments, a slider guide 120 may be slideably coupled to a hanger 280. For example, in some embodiments, a slider guide 120 may be able to be moved laterally on a hanger 280 to position the slider guide 120 at various positions along the length of hanger 280.

Hanger 280 may be fastened to a surface, such as a wall, through use of numerous types of fasteners 180. Examples of such fasteners 180 include, but are not limited to, screws, nuts, bolts, nails, and the like.

### Stabilizer 300

System 100, in some embodiments, may include one or more stabilizers 300. For example, in some embodiments, system 100 may include one stabilizer 300 (see e.g., FIGS. 39-41). In some embodiments, system 100 may include more than one stabilizer 300 (e.g., two, three, four, and the like) (not shown). In some embodiments, system 100 may not include a stabilizer 3000. In some embodiments, a slider guide 120 may be operably coupled to one or more stabilizers 300. In some embodiments, a stabilizer 300 may be operably coupled to one or more slider guides 120. In some embodiments, a stabilizer 300 may be permanently coupled to one or more slider guides 120. In some embodiments, a stabilizer 300 may be removeably coupled to one or more slider guides 120.

### Carrier 310

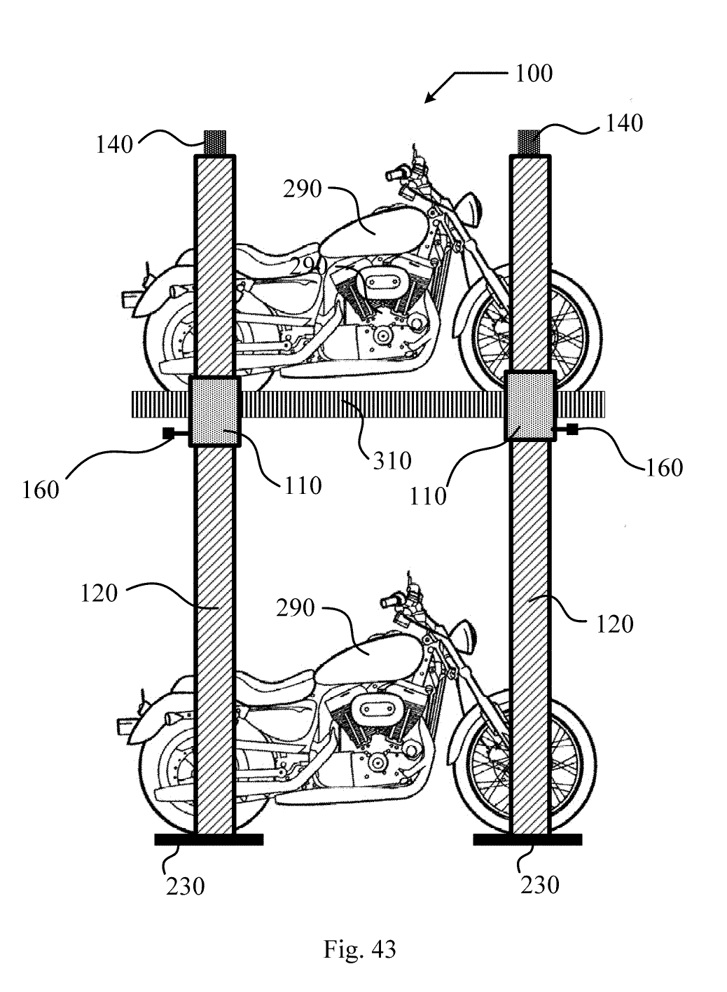

System 100, in some embodiments, may include one or more carriers 310. For example, in some embodiments, system 100 may include one carrier 310 (see e.g., FIG. 42). In some embodiments, system 100 may include more than one carrier 310 (e.g., two, three, four, and the like) (not shown). In some embodiments, system 100 may not include a carrier 310. In some embodiments, a carrier 310 may be operably coupled to one or more sliders 110. For example, in some embodiments, a carrier 310 may be operably coupled to a yoke 150 that is operably coupled to a slider 110 (see e.g., FIG. 42). In some embodiments, a carrier 310 may be permanently coupled to a slider 110. For example, in some embodiments, a carrier 310 may be welded to a slider 110. In some embodiments, a carrier 310 may be removeably coupled to a slider 110. For example, in some embodiments, a carrier 310 may be bolted to a slider 110. In some embodiments, a carrier 310 may be operably coupled to one or more sliders 110. In some embodiments, a carrier 310 may be configured to accept the wheels of a motorcycle 290 (see e.g., FIG. 43). Accordingly, positioning a motorcycle 290 on a carrier included within system 100 may allow a motorcycle 290 to be stored in an elevated position (see e.g., FIG. 43). In some embodiments system 100 may include more than one carrier 310 such that one or more motorcycles 290 may be stored in a vertical position.

### Platform 330

System 100, in some embodiments, may include one or more platforms 330. For example, in some embodiments, system 100 may include one platform 330 (see e.g., FIG. 46). In some embodiments, system 100 may include more than one platform 330 (e.g., two, three, four, and the like) (not shown). In some embodiments, system 100 may not include a platform 330. In some embodiments, a platform 330 may be operably coupled to one or more sliders 110. For example, in some embodiments, a platform 330 may be operably coupled to one or more yokes 150 that are operably coupled to one or more sliders 110 (see e.g., FIG. 46). In some embodiments, a platform 330 may be permanently coupled to a slider 110. For example, in some embodiments, a platform 330 may be welded to a slider 110. In some embodiments, a platform 330 may be removeably coupled to a slider 110. For example, in some embodiments, a platform 330 may be bolted to a slider 110. In some embodiments, a platform 330 may be operably coupled to one or more sliders 110.

### Bearing 340

System 100, in some embodiments, may include one or more bearings 340. For example, in some embodiments, system 100 may include one bearing 340. In some embodiments, system 100 may include more than one bearing 340 (e.g., two, three, four, and the like). In some embodiments, system 100 may not include a bearing 340.

One or more bearings 340 may be operably coupled to a slider 110 (see e.g., FIGS. 50 and 51). In some embodiments, one or more bearings 340 may be operably coupled to a slider 110 that is configured to be included within the interior of a tubular slider guide 120. Such a bearing(s) 340 may assist movement of the slider 110 within the slider guide 120. In some embodiments, a bearing(s) 340 may be configured to align a slider 110 within a tubular slider guide 120.

### Slider Stabilizer 350

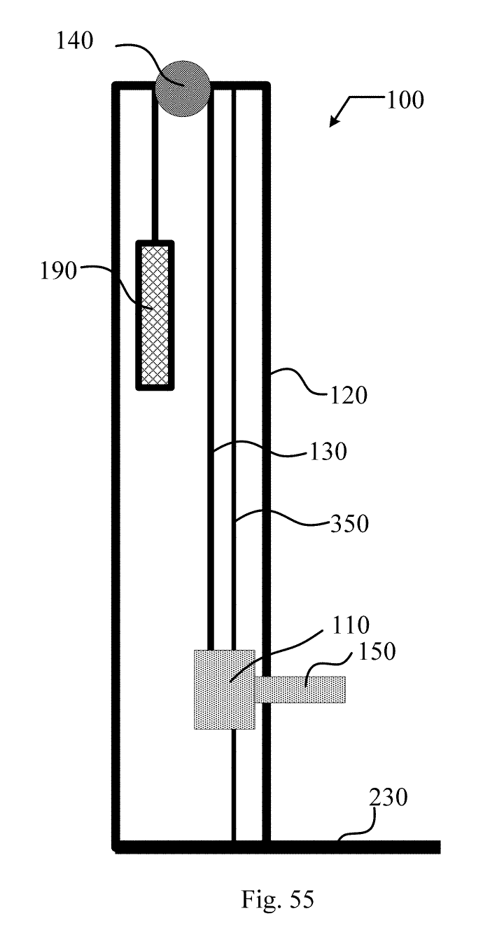

System 100, in some embodiments, may include one or more slider stabilizers 350. For example, in some embodiments, system 100 may include one slider stabilizer 350 (see e.g., FIG. 55). In some embodiments, system 100 may include more than one slider stabilizer 350 (e.g., two, three, four, and the like) (not shown). In some embodiments, system 100 may not include a slider stabilizer 350.

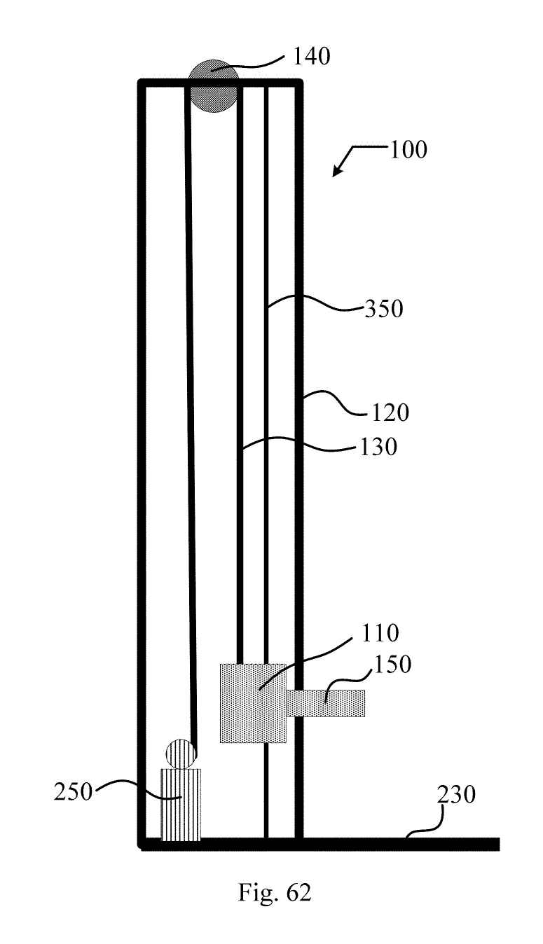

In some embodiments, one or more slider stabilizers 350 may be operably coupled to a slider 110 (see e.g., FIGS. 55 and 62). In some embodiments, one or more slider stabilizers 350 may be operably coupled to a slider 110 that is configured to be included within the interior of a tubular slider guide 120. Such a slider stabilizer(s) 350 may stabilize movement of the slider 110 within the slider guide 120. In some embodiments, a slider stabilizer 350 may pass through a channel included within a slider 110. In some embodiments, a slider stabilizer 350 may pass through a bracket 170 that is operably coupled to a slider 110.

### Motor 360

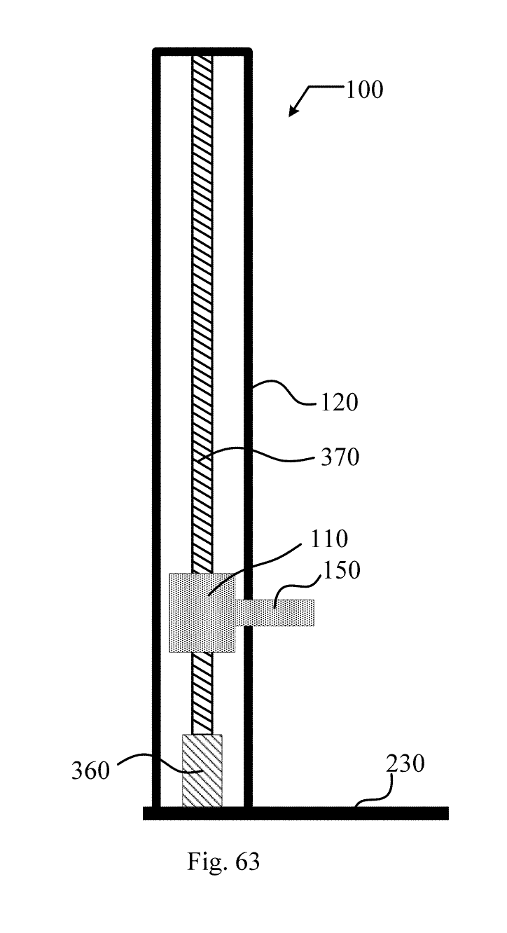

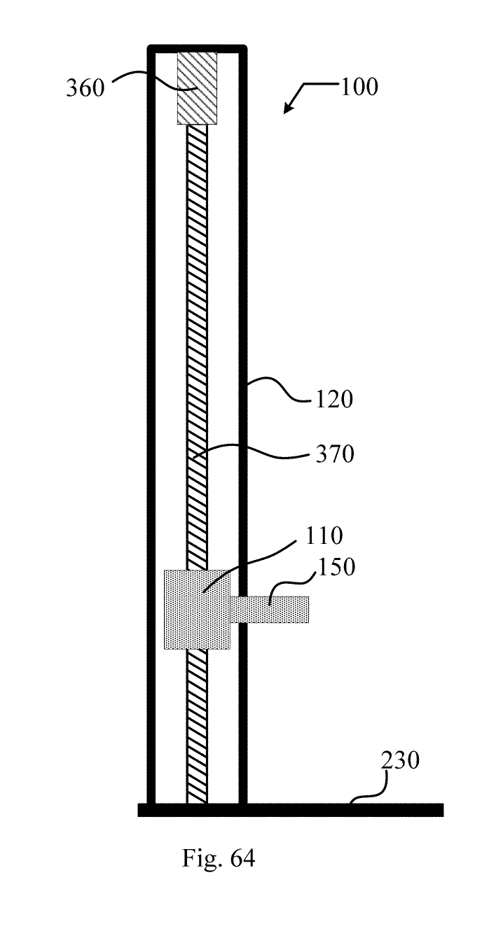

System 100, in some embodiments, may include one or more motors 360. For example, in some embodiments, system 100 may include one motor 360 (see e.g., FIGS. 63 and 64). In some embodiments, system 100 may include more than one motor 360 (e.g., two, three, four, and the like) (not shown). In some embodiments, system 100 may not include a motor 360.

Numerous types of motors 360 may be used within system 100. Examples of such motors 360 include, but are not limited to, an electric motor 360, a squiggle motor 360, an AC motor 360, a DC motor 360, and the like. Accordingly, in some embodiments, system 100 may include a control system to control operation of a motor. In some embodiments, system 100 may include a battery to provide electrical energy to operate a motor 360. In some embodiments, system 100 may utilize line electricity to provide electrical energy to operate a motor 360.

In some embodiments, one or more motors 360 may be operably coupled to a threaded member 370 (see e.g., FIGS. 63 and 64). Accordingly, in some embodiments, operation of such a motor 360 may cause rotation of the operaby coupled threaded member 370. In some embodiments, one or more threaded members 370 may be operably coupled to a slider 110. In some embodiments, a threaded member 370 may pass through a threaded channel included within a slider 110. Accordingly, rotation of a threaded member 370 that is operably coupled to a slider 110 may cause movement of the slider 110. In some embodiments, such a slider 110 may be configured to be included within the interior of a slider guide 120 (see e.g., FIGS. 63 and 64). In some embodiments, such a slider 110 may be configured to be operably coupled to the exterior of a slider guide 120 (not shown).

### Tensioner 380

System 100, in some embodiments, may include one or more tensioners 380. For example, in some embodiments, system 100 may include one tensioner 380 (see e.g., FIG. 45). In some embodiments, system 100 may include more than one tensioner 380 (e.g., two, three, four, and the like) (not shown). In some embodiments, system 100 may not include a tensioner 380. In some embodiments, a tensioner 380 may be manual. In some embodiments, a tensioner 380 may be electronically controlled. For example, in some embodiments, a tensioner 380 may include electrical circuitry and one or more electrical motors that control operation of the tensioner 380.

In some embodiments, a tensioner 380 may be configured to regulate the resistance with which a slider 110 moves on a slider guide 120. For example, in some embodiments, a tensioner 380 may be adjusted to increase or decrease resistance to movement of a slider 110 on a slider guide 120. In some embodiments, the tensioner 380 may be adjusted in response to a load that is applied to a slider 110. For example, in some embodiments, system 100 may include a weight 190 that is operably coupled to a slider support 130 which is in turn operably coupled to slider 110. Accordingly, in such embodiments, a tensioner 380 may be adjusted to provide resistance to balance the force provide by the weight 190 with the load applied to the slider 110. In some embodiments, the amount of force applied by a tensioner 380 may be automatically adjusted through the action of a load control system 1000.

A tensioner 380 may be configured in numerous ways. For example, in some embodiments, tensioner 380 may be configured as a clamp that is operably coupled to a slider 110 and moveably coupled to an operably coupled slider guide 120 such that increasing or decreasing the force of the clamp on the slider guide 120 will increase or decrease resistance to movement of the slider 110 on the slider guide 120. In some embodiments, tensioner 380 may be configured as a friction plate that is operably coupled to a slider 110 and slideably coupled to a slide guide 120 such that increasing or decreasing the force of the friction plate on the slider guide 120 will increase or decrease resistance to movement of the slider 110 on the slider guide 120. In some embodiments, tensioner 380 may be operably coupled to a rotatable member 140. For example, in some embodiments, a tensioner 380 may be configured as a clamp that is operably coupled to an axle that is coupled to the rotatable member 140. Accordingly, increasing the clamping force on the axle may increase rotational resistance on the rotatable member 140. In some embodiments, a tensioner 380 may be configured as a friction plate that engages the rotatable member 140. Accordingly, in some embodiments, increasing the force with which the friction plate engages the rotatable member 140 may increase rotational resistance on the rotatable member 140. Accordingly, in such embodiments, increasing or decreasing the force of the tensioner 380 on the rotatable member 140 will increase or decrease the resistance to movement of the slider 110 on the slider guide 120 by regulating the amount of force applied to a slider support 130 that is operaby coupled to the slider 110. In some embodiments, a tensioner 380 may be operably coupled to a slider support 130 that is operably coupled to a slider 110 to adjust the resistance with which a slider 110 may move on a slider guide 120. For example, in some embodiments, a tensioner 380 may be configured as a clamp that engages the slider support 130. Accordingly, in some embodiments, the force with which the clamp engages the slider support 130 may be adjusted to increase or decrease the resistance to motion of the operably coupled slider 110.

In some embodiments, one or more tensioners 380 may be operably coupled to one or more sensors that detect load applied to one or more sliders 110 and facilitate adjustment of the one or more tensioners 380 in response to the detected load to increase or decrease resistance to movement of the one or more sliders 110.

### Load Control System 1000

System 100, in some embodiments, may include a load control system 1000. In some embodiments, system 100 may not include a load control system. Generally, a load control system 1000 may regulate the resistance with which a slider 110 moves on a slider guide 120 in response to a load applied to the slider 110. For example, in some embodiments, a load control system 1000 may control how a load applied to a slider 110 is counterbalanced.

In some embodiments, load control system 1000 may include circuitry configured to adjust the resistance with which a slider 110 moves on a slider support 130. In some embodiments, load control system 1000 may include circuitry configured to adjust the resistance with which a slider 110 moves on a slider support 130 in response to a load applied to the slider 110. Accordingly, in some embodiments, load control system 1000 may include a combination of hardware, software, and/or circuitry. For example, in some embodiments, load control system 1000 may include electronic sensors, transmitters, receivers, central processing units, and the like.

Accordingly, in some embodiments, a load control system 1000 may include one or more sensors 1002 that may detect a load applied to a slider 110. In some embodiments, a weight sensor 1008 may detect a load applied to slider 110 through weighing the load. For example, in some embodiments, such a weight sensor 1008 may be operably coupled to a slider support 130 to weigh a load applied to a slider 110. In some embodiments, a weight sensor 1008 may be operably coupled to a rotatable member 140 to weigh a load applied to a slider 110. For example, in some embodiments, a weight sensor 1008 may be operably coupled with a rotatable member 140 over which a sider support 130 passes such that compression of the rotatable member 140 indicates the weight of the load. In some embodiments, a stretch sensor 1010 may measure how much a slider support 130 that is operably coupled to a slider 110 stretches in response to a load applied to the slider 110 to measure the applied load. Accordingly, sensors may be configured in numerous ways to determine a load applied to a slider 110.

In some embodiments, the one or more sensors 1002 may receive and/or transmit one or more signals. Accordingly, in some embodiments, a sensor 1002 may include one or more sensor receivers 1004 and/or one or more sensor transmitters 1006. A sensor 1002 may be configured to receive and/or transmit numerous types of signals 1026. Examples of such signals 1026 include, but are not limited to, Bluetooth signals, wireless signals, hardwired signals, infrared signals, and the like.

In some embodiments, a sensor 1002 may transmit a signal 1026 to a load control unit 1012 that is related to a load applied to a slider 110. In some embodiments, a sensor 1002 may transmit a signal 1026 to a tensioner 1020 that is related to a load applied to a slider 110. In some embodiments, a sensor 1002 may receive a signal 1026 transmitted by a load control unit 1012. In some embodiments, a sensor 1002 may receive a signal 1026 transmitted by a tensioner 1020.

In some embodiments, load control system 1000 may include one or more load control units 1012. Generally, a load control unit 1012 may receive information with regard to one or more loads applied to one or more sliders 110, determine an amount of force to counterbalance the one or more applied loads, and then instruct one or more tensioners 1020 to apply an amount of force to counterbalance the one or more loads applied to the one or more sliders 110.

In some embodiments, a load control unit 1012 may include one or more load control receivers 1014. In some embodiments, a load control unit 1012 may include one or more load control transmitters 1016. A load control unit 1012 may be configured to receive and/or transmit numerous types of signals 1026. Examples of such signals 1026 include, but are not limited to, Bluetooth signals, wireless signals, hardwired signals, infrared signals, and the like. In some embodiments, a load control unit may receive one or more signals from one or more sensors 1002. In some embodiments, a load control unit 1012 may receive one or more signals 1026 from one or more tensioners 1020. In some embodiments, a load control unit 1012 may transmit one or more signals 1026.

In some embodiments, a load control unit 1012 may include one or more load control processors 1018 (e.g., central processing unit). A load control processor 1018 may determine an amount of force to be applied by one or more tensioners 1020 through use of numerous methods. For example, in some embodiments, a load control processor 1018 may determine an amount of force to be applied by one or more tensioners 1020 based on a weight 190 included within system 100 and the weight of an applied load to one or more sliders 110 included within system 100 to counterbalance the applied load. In some embodiments, a load control processor 1018 may determine an amount of force to be applied by one or more tensioners 1020 based on the spring constant of a spring 240 included within system 100 and the weight of an applied load to one or more sliders 110 included within system 100 to counterbalance the applied load.

In some embodiments, load control system 1000 may include one or more tensioners 1020. In some embodiments, a tensioner 1020 may include one or more tensioner receivers 1022. In some embodiments, a tensioner 1020 may include one or more tensioner transmitters 1024. A tensioner 1020 may be configured to receive and/or transmit numerous types of signals 1026. Examples of such signals include, but are not limited to, Bluetooth signals, wireless signals, hardwired signals, infrared signals, and the like. In some embodiments, a tensioner 1020 may receive one or more signals 1026 from one or more sensors 1002. In some embodiments, a tensioner 1020 may receive one or more signals 1002 from one or more load control units 1012. In some embodiments, a tensioner 1020 may transmit one or more signals 1026 that are received by one or more load control units 1012 and/or sensors 1002.

In some embodiments, load control system 1000 may include one or more user interfaces 1028. In some embodiments, a user interface 1028 may be operably coupled with a sensor 1002, a load control unit 1012, and/or a tensioner 1020. Accordingly, in some embodiments, a user interface 1028 may be include one or more transmitters and/or one more receivers. A user interface 1028 may be configured to receive and/or transmit numerous types of signals 1026. Examples of such signals include, but are not limited to, Bluetooth signals, wireless signals, hardwired signals, infrared signals, and the like.

A user interface 1028 may be configured to receive numerous types of user input. For example, a user interface may include a touchpad, a keyboard, a joystick, a receiver configured to receive instructions from a mobile device (e.g., a cellular telephone), and the like.

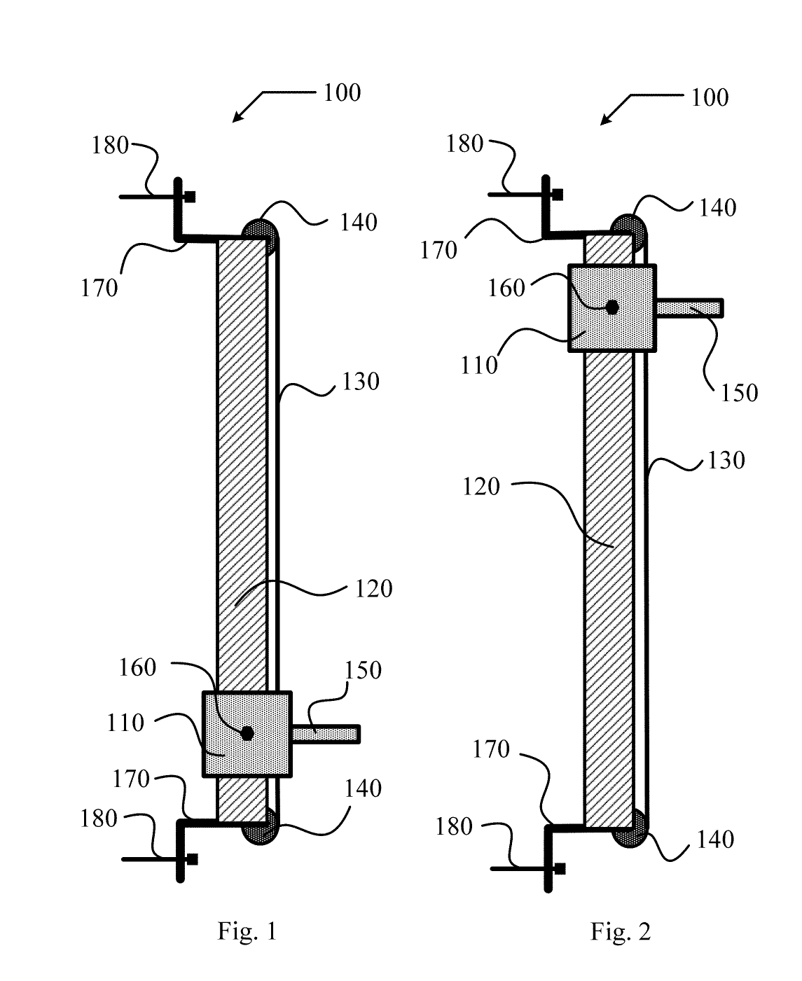

FIG. 1 illustrates a side-view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to upper and lower portions of slider 110. Slider support 130 is also shown as being operably coupled to rotatable members 140 such that slider support 130 is able to travel over rotatable members 140 when slider 110 is moved relative to slider support 130 (see, e.g., FIG. 2). In some embodiments, system 100 may include a weight 190 that is operably coupled to slider support 130 and contained within the interior of slider guide 120 (not shown, see e.g., FIGS. 5-8). In some embodiments, system 100 may not include a weight 190. Slider 110 is shown as being operably coupled to yoke 150. Yoke 150 is illustrated as a male yoke 150 in FIG. 1. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to brackets 170. Brackets 170 are shown as being operably coupled to fasteners 180.

FIG. 2 illustrates a side-view of an embodiment of system 100. The embodiment shown in FIG. 2 corresponds to an embodiment of system 100 as shown in FIG. 1 with slider 110 being positioned in a raised position relative to slider guide 120.

FIG. 3 illustrates a side-view of an embodiment of system 100. The embodiment shown in FIG. 3 corresponds to an embodiment of system 100 as shown in FIG. 1 with slider 110 being positioned in a lowered position relative to slider guide 120. Also, slider 110 is shown as being operably coupled to yoke 150 that is configured as a female yoke 150.

FIG. 4 illustrates a side-view of an embodiment of system 100. The embodiment shown in FIG. 4 corresponds to an embodiment of system 100 as shown in FIG. 3 with slider 110 being positioned in a raised position relative to slider guide 120.

FIG. 5 illustrates a partial cross-sectional view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to upper and lower portions of slider 110. Slider support 130 is also shown as being operably coupled to rotatable members 140 such that slider support 130 is able to travel over rotatable members 140 when slider 110 is moved relative to slider support 130 (see e.g., FIG. 6). In some embodiments, system 100 may include a weight 190 that is operably coupled to slider support 130 and contained within the interior of slider support 120. Slider 110 is shown as being operably coupled to yoke 150. Yoke 150 is illustrated as a male yoke 150 in FIG. 5. Slider 110 is shown as optionally including slider detainer 160. In some embodiments, slider detainer 160 may be configured to reversibly lock slider 110 onto slider support 120 at numerous positions on slider guide 120. Slider guide 120 is shown as being operably coupled to bracket 170. Bracket 170 is shown as being operably coupled to fastener 180.

FIG. 6 illustrates a partial cross-sectional view of an embodiment of system 100. The embodiment shown in FIG. 6 corresponds to an embodiment of system 100 as shown in FIG. 5 with slider 110 being positioned in a raised position relative to slider guide 120.

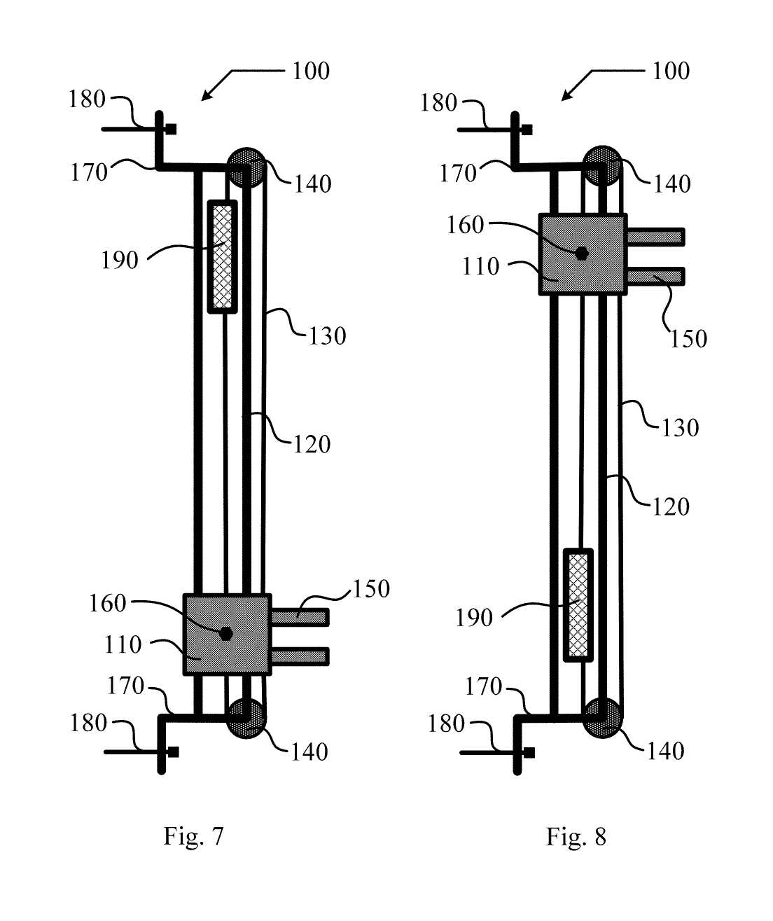

FIG. 7 illustrates a partial cross-sectional view of an embodiment of system 100. The embodiment shown in FIG. 7 corresponds to an embodiment of system 100 as shown in FIG. 5 with slider 110 being positioned in a lowered position relative to slider guide 120. Also, slider 110 is shown as being operably coupled to yoke 150 that is configured as a female yoke 150.

FIG. 8 illustrates a partial cross-sectional view of an embodiment of system 100. The embodiment shown in FIG. 8 corresponds to an embodiment of system 100 as shown in FIG. 7 with slider 110 being positioned in a raised position relative to slider guide 120.

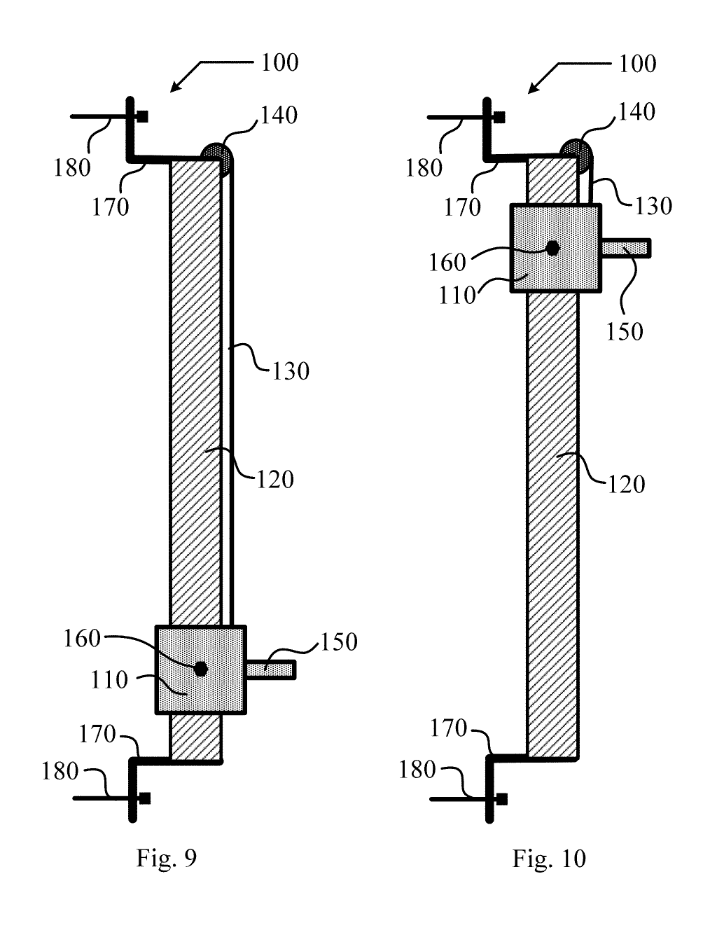

FIG. 9 illustrates a side-view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130 (see e.g., FIG. 10). In some embodiments, system 100 may include a weight 190 that is operably coupled to slider support 130 and contained within the interior of slider support 120 (not shown, see e.g., FIGS. 13 and 14). Slider 110 is shown as being operably coupled to yoke 150. Yoke 150 is illustrated as a male yoke 150 in FIG. 9. Slider 110 is shown as optionally including slider detainer 160. In some embodiments, slider detainer 160 may be configured to reversibly lock slider 110 onto slider support 120 at numerous positions. Slider guide 120 is shown as being operably coupled to bracket 170. Bracket 170 is shown as being operably coupled to fastener 180.

FIG. 10 illustrates a side-view of an embodiment of system 100. The embodiment shown in FIG. 10 corresponds to an embodiment of system 100 as shown in FIG. 9 with slider 110 being positioned in a raised position relative to slider guide 120.

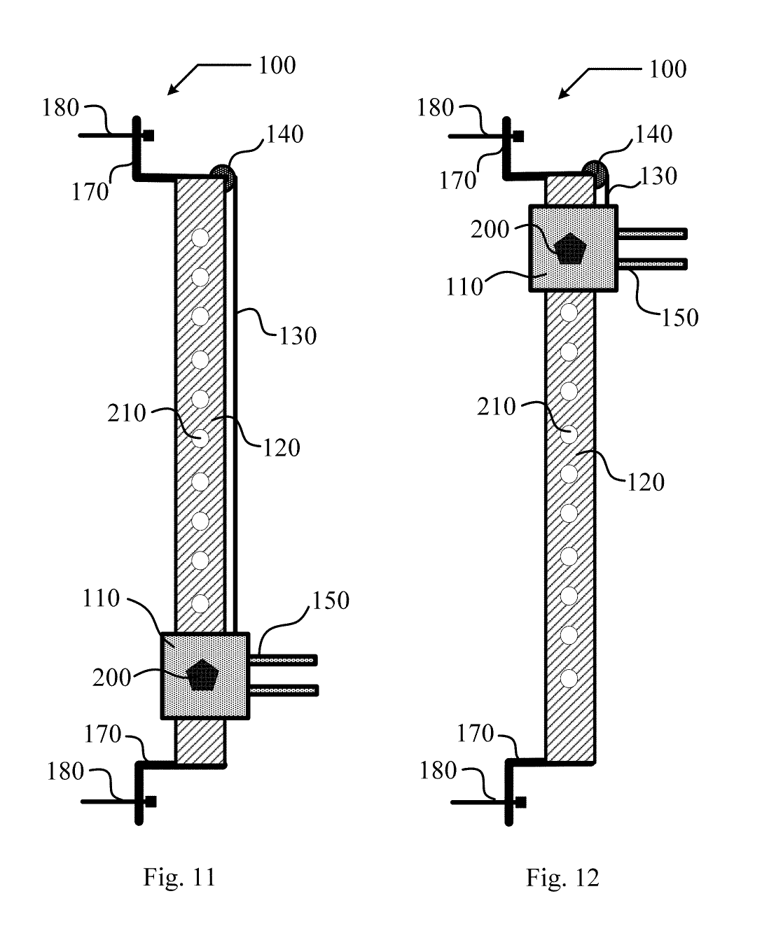

FIG. 11 illustrates a side-view of an embodiment of system 100. The embodiment shown in FIG. 11 corresponds to an embodiment of system 100 as shown in FIG. 9 with slider 110 being positioned in a lowered position relative to slider guide 120. Slider 110 is shown as being operably coupled to yoke 150 that is configured as a female yoke 150. FIG. 11 also shows slider 110 as being operably coupled to retainer pin 200 and a series of retainer pin receivers 210 positioned at various positions on slider guide 120. In some embodiments, retainer pin 200 may be configured to be received by a retainer pin receiver 210. Accordingly, in some embodiments, slider 110 may be secured at various positions along slider guide 120 through insertion of retainer pin 200 into retainer pin receiver 210.

FIG. 12 illustrates a side-view of an embodiment of system 100. The embodiment shown in FIG. 12 corresponds to an embodiment of system 100 as shown in FIG. 11 with slider 110 being positioned in a raised position relative to slider guide 120.

FIG. 13 illustrates a partial cross-sectional view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130 (see e.g., FIG. 14). In some embodiments, system 100 may include a weight 190 that is operably coupled to slider support 130 and contained within the interior of slider support 120. Slider 110 is shown as being operably coupled to yoke 150. Yoke 150 is illustrated as a male yoke 150 in FIG. 13. Slider 110 is shown as optionally including slider detainer 160. In some embodiments, slider detainer 160 may be configured to reversibly lock slider 110 onto slider support 120 at numerous positions on slider guide 120. Slider guide 120 is shown as being operably coupled to bracket 170. Bracket 170 is shown as being operably coupled to fastener 180.

FIG. 14 illustrates a partial cross-sectional view of an embodiment of system 100. The embodiment shown in FIG. 14 corresponds to an embodiment of system 100 as shown in FIG. 13 with slider 110 being positioned in a raised position relative to slider guide 120.

FIG. 15 illustrates a partial cross-sectional view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is shown as optionally including rollers 220 that are positioned on the interior of slider 110 and configured to roll on an exterior surface of slider guide 120. Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130 (see e.g., FIG. 14). In some embodiments, system 100 may include a weight 190 that is operably coupled to slider support 130 and contained within the interior of slider support 120. Slider 110 is shown as being operably coupled to yoke 150. Yoke 150 is illustrated as a male yoke 150 in FIG. 15. Slider 110 may optionally including slider detainer 160 (not shown). In some embodiments, slider detainer 160 may be configured to reversibly lock slider 110 onto slider support 120 at numerous positions on slider guide 120. Slider guide 120 is shown as being operably coupled to bracket 170. Bracket 170 is shown as being operably coupled to fastener 180.

FIG. 16 illustrates a partial cross-sectional view of an embodiment of system 100. The embodiment shown in FIG. 16 corresponds to an embodiment of system 100 as shown in FIG. 13 with slider 110 being positioned in a lowered position relative to slider guide 120. Also, slider 110 is shown as being operably coupled to yoke 150 that is configured as a female yoke 150.

FIG. 17 illustrates a partial cross-sectional view of an embodiment of system 100. The embodiment shown in FIG. 17 corresponds to an embodiment of system 100 as shown in FIG. 16 with slider 110 being positioned in a raised position relative to slider guide 120.

FIG. 18 illustrates a side-view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to upper and lower portions of slider 110. Slider support 130 is also shown as being operably coupled to rotatable members 140 such that slider support 130 is able to travel over rotatable members 140 when slider 110 is moved relative to slider support 130 (see e.g., FIG. 19). In some embodiments, system 100 may include a weight 190 that is operably coupled to slider support 130 and contained within the interior of slider support 120 (not shown, see e.g., FIGS. 16 and 17). In some embodiments, system 100 may not include a weight 190. Slider 110 is shown as being operably coupled to yoke 150. Yoke 150 is illustrated as a male yoke 150 in FIG. 18. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being optionally operably coupled to brackets 170. Brackets 170 are shown as being operably coupled to fasteners 180. Slider guide 120 is also shown as being operably coupled to base plate 230.

FIG. 19 illustrates a side-view of an embodiment of system 100. The embodiment shown in FIG. 19 corresponds to an embodiment of system 100 as shown in FIG. 18 with slider 110 being positioned in a raised position relative to slider guide 120. The embodiment illustrated in FIG. 19 lacks brackets 170 and fasteners 180 as illustrated in FIG. 18.

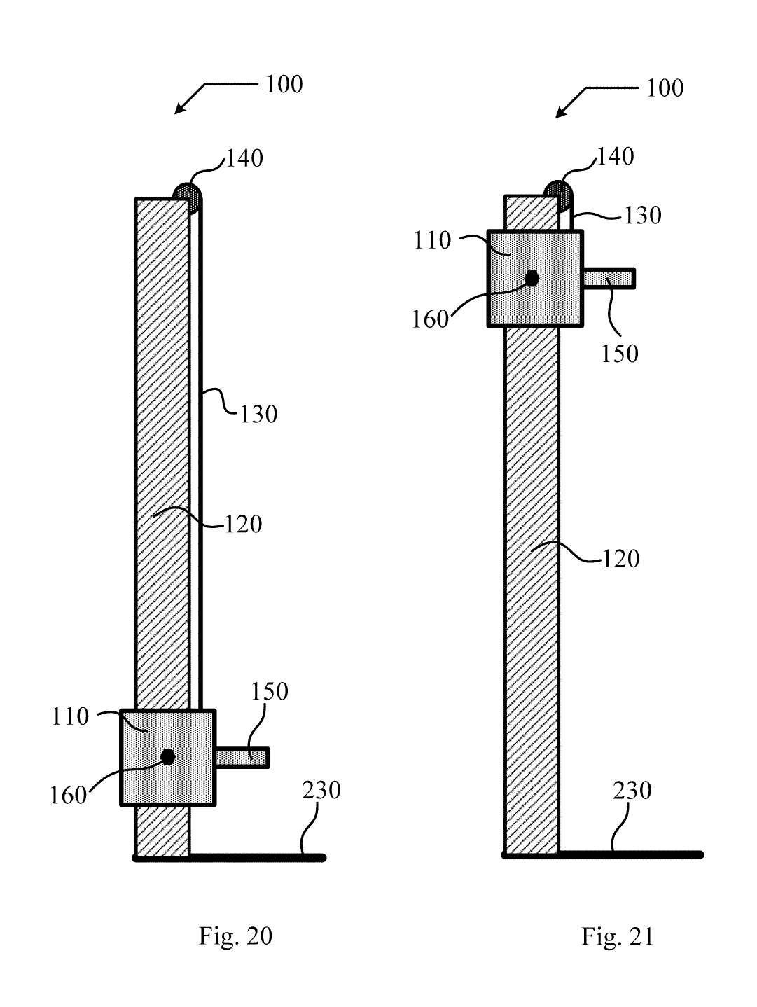

FIG. 20 illustrates a side-view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable members 140 when slider 110 is moved relative to slider support 130 (see e.g., FIG. 21). In some embodiments, system 100 may include a weight 190 that is operably coupled to slider support 130 and contained within the interior of slider support 120 (not shown, see e.g., FIGS. 16 and 17). Slider 110 is shown as being operably coupled to yoke 150. Yoke 150 is illustrated as a male yoke 150 in FIG. 20. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to base plate 230.

FIG. 21 illustrates a side-view of an embodiment of system 100. The embodiment shown in FIG. 21 corresponds to an embodiment of system 100 as shown in FIG. 20 with slider 110 being positioned in a raised position relative to slider guide 120.

FIG. 22 illustrates a partial cross-sectional view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130 (see e.g., FIG. 23). In some embodiments, system 100 may include a spring 240 that is operably coupled to slider support 130 and slider guide 120 and/or bracket 170. Spring 240 is shown as being contained within the interior of slider support 120 in an extended configuration. Slider 110 is shown as being operably coupled to yoke 150. Yoke 150 is illustrated as a male yoke 150 in FIG. 22. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to brackets 170. Brackets 170 are shown as being operably coupled to fasteners 180.

FIG. 23 illustrates a partial cross-sectional view of an embodiment of system 100. The embodiment shown in FIG. 23 corresponds to an embodiment of system 100 as shown in FIG. 22 with slider 110 being positioned in a raised position relative to slider guide 120. Spring 240 is shown as being in a non-extended position.

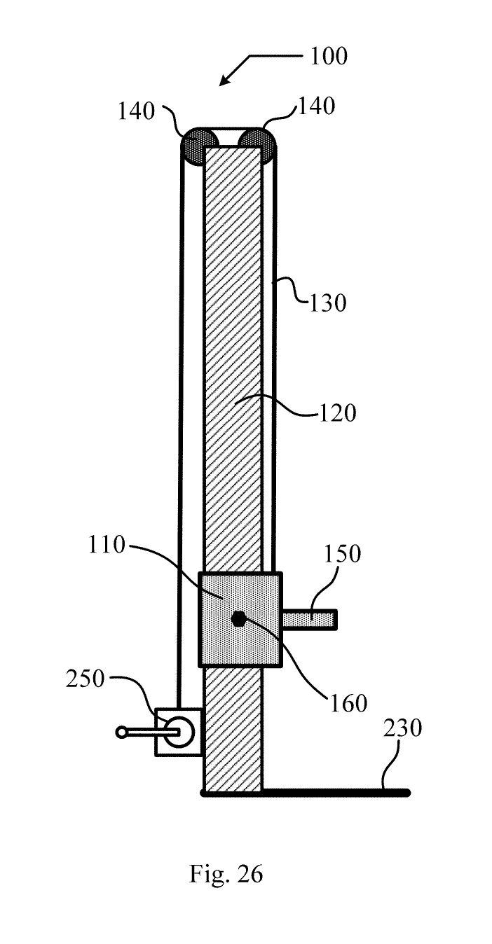

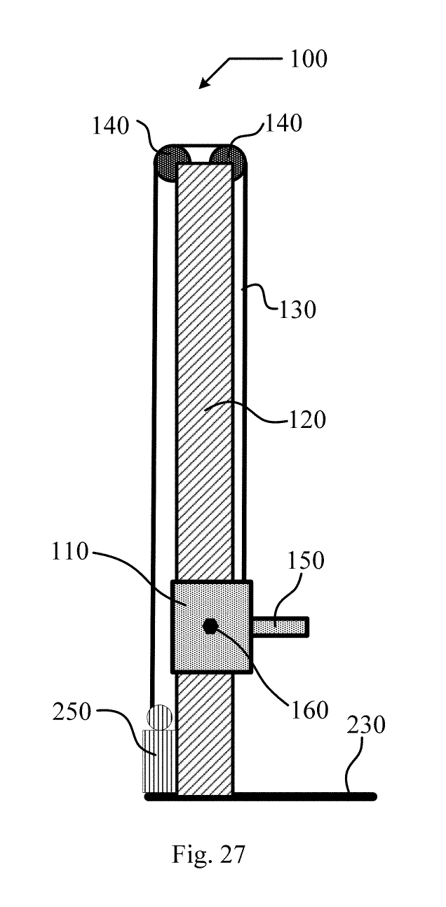

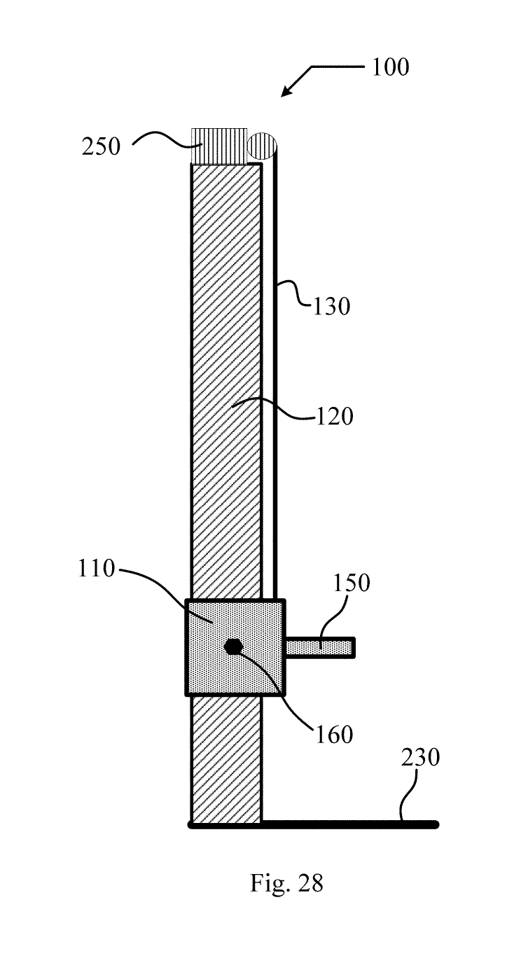

FIG. 24 illustrates a partial cross-sectional view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130 (see e.g., FIG. 25). In some embodiments, system 100 may include an electric winch 250 that is operably coupled to slider support 130 and slider guide 120 and/or bracket 170. Electric winch 250 is shown as being contained within the interior of slider support 120. Slider 110 is shown as being operably coupled to yoke 150. Yoke 150 is illustrated as a male yoke 150 in FIG. 24. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to brackets 170. Brackets 170 are shown as being operably coupled to fasteners 180.

FIG. 25 illustrates a partial cross-sectional view of an embodiment of system 100. The embodiment shown in FIG. 25 corresponds to an embodiment of system 100 as shown in FIG. 24 with slider 110 being positioned in a raised position relative to slider guide 120.

FIG. 26 illustrates a side-view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is also shown as being operably coupled to rotatable members 140 such that slider support 130 is able to travel over rotatable members 140 when slider 110 is moved relative to slider support 130. In some embodiments, system 100 may include a manual winch 250 that is operably coupled to slider support 130 and slider support 120 and/or base plate 230 in some embodiments. Manual winch 250 is shown as being operably coupled to the exterior of slider support 120. Slider 110 is shown as being operably coupled to yoke 150. Yoke 150 is illustrated as a male yoke 150 in FIG. 26. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to base plate 230.

FIG. 27 illustrates a side-view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is also shown as being operably coupled to rotatable members 140 such that slider support 130 is able to travel over rotatable members 140 when slider 110 is moved relative to slider support 130. In some embodiments, system 100 may include an electric winch 250. Electric winch 250 may be operably coupled to the exterior of slider support 120 and/or base plate 230. Slider 110 is shown as being operably coupled to yoke 150. Yoke 150 is illustrated as a male yoke 150 in FIG. 27. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to base plate 230.

FIG. 28 illustrates a side-view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is also shown as being operably coupled to electric winch 250. Electric winch 250 is shown as being operably coupled to the exterior of slider support 120. Slider 110 is shown as being operably coupled to yoke 150. Yoke 150 is illustrated as a male yoke 150 in FIG. 28. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to base plate 230.

FIG. 29 illustrates a partial cross-sectional view of an embodiment of system 100. Slider 110 is shown as being operably coupled to slider guide 120 with slider 110 being positioned in a lowered position relative to slider guide 120. The slider guide 120 is shown as including a toothed track 270. In this embodiment, slider 110 is shown as encircling slider guide 120 with slider guide 120 passing through the interior of slider 110 (see, e.g., FIG. 47). A mechanical winch 250 is included within the interior of slider 110. The mechanical winch 250 includes a cog 260 that is configured to engage with the toothed track 270 on the slider guide 120 such that operating the mechanical winch 250 will move the slider 110 relative to the slider guide 120. Slider 110 is shown as being operably coupled to yoke 150. Yoke 150 is illustrated as a male yoke 150 in FIG. 29. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to base plate 230.

FIG. 30 illustrates a cross-sectional transverse view of an embodiment of system 100. Slider guide 120 is shown as being a substantially square tube that includes a toothed track 270 on an interior surface of slider guide 120. In this embodiment, slider 110 is shown as being a substantially square tube that is included within the interior of slider guide 120 with yoke 150 passing through a channel in slider guide 120. An electric winch 250 is included within the interior of slider 110. The electric winch 250 includes a cog 260 that is configured to engage the toothed track 270 included on an interior surface of slider guide 120 such that operating the electric winch 250 will move the slider 110 relative to the slider guide 120. Yoke 150 is illustrated as a male yoke 150 in FIG. 30.

FIG. 31 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 30). Slider 110 is shown as being operably coupled to slider guide 120 with slider 110 being positioned in a lowered position relative to slider guide 120. Slider guide 120 is shown as including a toothed track 270 on an interior surface of slider guide 120. An electric winch 250 is included within the interior of slider 110. The electric winch 250 includes a cog 260 that is configured to engage the toothed track 270 on the interior of slider guide 120 such that operating the electric winch 250 will move the slider 110 relative to the slider guide 120. Slider 110 is shown as being operably coupled to yoke 150. Yoke 150 is illustrated as a male yoke 150 in FIG. 31. Slider guide 120 is shown as being operably coupled to base plate 230.

FIG. 32 illustrates a front-view of an embodiment of system 100. Slider 110 is shown as being operably coupled to slider guide 120 with slider 110 being positioned at an intermediate position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to upper and lower portions of slider 110. Slider support 130 is also shown as being operably coupled to rotatable members 140 such that slider support 130 is able to travel over rotatable members 140 when slider 110 is moved relative to slider support 130 (see e.g., FIG. 2). In some embodiments, system 100 may include a weight 190 that is operably coupled to slider support 130 and contained within the interior of slider support 120 (not shown, see e.g., FIGS. 5-8). In some embodiments, system 100 may not include a weight 190. Slider 110 is shown as being operably coupled to yoke 150. Yoke 150 is illustrated as a female yoke 150 in FIG. 32. Slider guide 120 is shown as being operably coupled to hanger 280. In some embodiments, slider guide 120 may be permanently coupled to hanger 280. In some embodiments, slider guide 120 may be reversibly coupled to hanger 280. Hanger 280 is shown as being operably coupled to fasteners 180.

FIG. 33 illustrates a front-view of an embodiment of system 100. The embodiment shown in FIG. 33 corresponds to an embodiment of system 100 as shown in FIG. 32 except with slider 110 being coupled to a yoke 150 that is a male yoke 150.

FIG. 34 illustrates a front-view of an embodiment of system 100. Slider 110 is shown as being operably coupled to slider guide 120 with slider 110 being positioned at an intermediate position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to an upper portion of slider 110. Slider support 130 is shown as being operably coupled to a rotatable member 140 such that slider support 130 is able to travel over rotatable member 140 when slider 110 is moved relative to slider support 130 (see e.g., FIG. 2). In some embodiments, system 100 may include a weight 190 that is operably coupled to slider support 130 and contained within the interior of slider support 120 (not shown, see e.g., FIGS. 5-8). In some embodiments, system 100 may include a spring 240 that is operably coupled to slider support 130 and contained within the interior of slider support 120 (not shown, see e.g., FIGS. 22 and 23). In some embodiments, system 100 may include a winch 250 that is operably coupled to slider support 130. Slider 110 is shown as being operably coupled to yoke 150. Yoke 150 is illustrated as a female yoke 150 in FIG. 34. Slider guide 120 is shown as being operably coupled to hangers 280. In some embodiments, slider guide 120 may be permanently coupled to hangers 280. In some embodiments, slider guide 120 may be reversibly coupled to hangers 280. Hangers 280 are shown as being operably coupled to fasteners 180.

FIG. 35 illustrates a front-view of an embodiment of system 100. The embodiment shown in FIG. 35 corresponds to an embodiment of system 100 as shown in FIG. 34 except with slider 110 being coupled to a yoke 150 that is a male yoke 150 and including a single hanger 280.

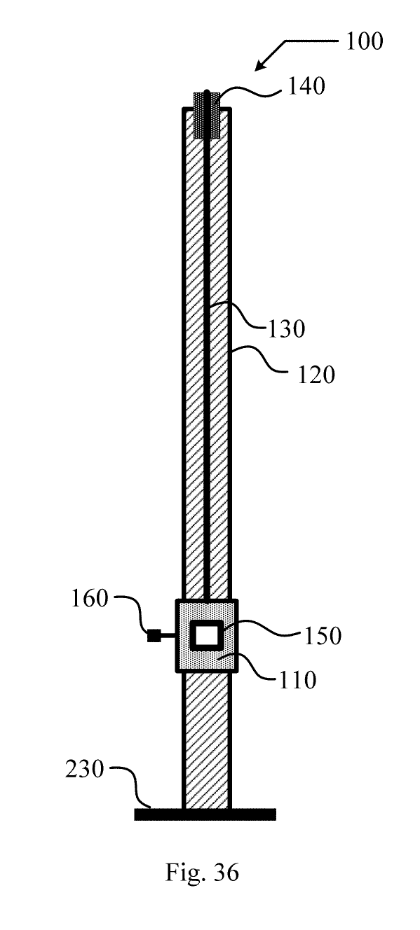

FIG. 36 illustrates a front-view of an embodiment of system 100. Slider 110 is shown as being operably coupled to slider guide 120 with slider 110 being positioned at a lower position relative to slider guide 120. In this embodiment, slider 110 is shown as encircling slider guide 120 with slider guide 120 passing through the interior of slider 110 (see, e.g., FIG. 47). Slider 110 is shown as being operably coupled to optional slider detainer 160. In some embodiments, slider detainer 160 may be used to lock slider 110 at numerous positions relative to slider guide 120. Slider 110 is operably coupled to slider support 130. Slider support 130 is shown as being operably coupled to an upper portion of slider 110. Slider support 130 is also shown as being operably coupled to a rotatable member 140 such that slider support 130 is able to travel over rotatable member 140 when slider 110 is moved relative to slider support 130 (see e.g., FIG. 2). In some embodiments, system 100 may include a weight 190 that is operably coupled to slider support 130 and contained within the interior of slider support 120 (not shown, see e.g., FIGS. 5-8). In some embodiments, system 100 may include a spring 240 that is operably coupled to slider support 130 and contained within the interior of slider support 120 (not shown, see e.g., FIGS. 22 and 23). In some embodiments, system 100 may include a winch 250 that is operably coupled to slider support 130. Slider 110 is shown as being operably coupled to yoke 150. Yoke 150 is illustrated as a female yoke 150 in FIG. 36. Slider guide 120 is shown as being operably coupled to base plate 230.

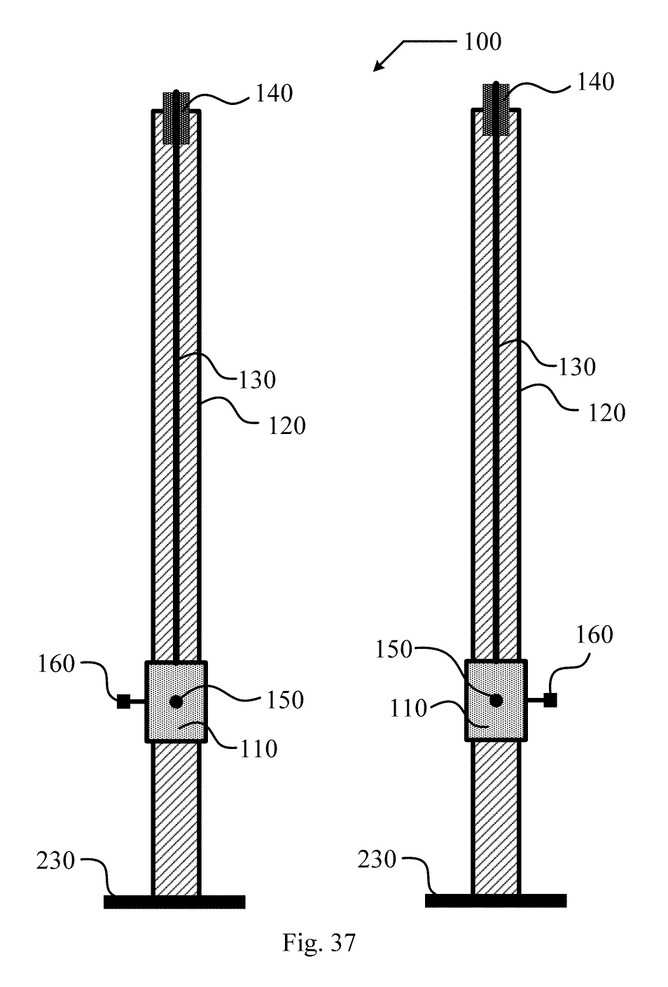

FIG. 37 illustrates a front-view of an embodiment of system 100. The embodiment of system 100 shown in FIG. 37 corresponds to an embodiment of system 100 as shown in FIG. 36 except with slider 110 being operably coupled to a yoke 150 that is configured to be inserted into a motorcycle hub.

FIG. 38 illustrates a rear-view of an embodiment of system 100. The embodiment of system 100 shown in FIG. 38 corresponds to an embodiment of system 100 as shown in FIG. 36 except with slider 110 being operably coupled to a yoke 150 that is configured to be inserted into a motorcycle hub. In FIG. 38, a first motorcycle 290 is shown coupled to system 100 and held in an elevated position. In this instance, one yoke 150 of system 100 has been inserted into a front hub of motorcycle 290 and a second yoke 150 of system 100 has been inserted into a rear hub of motorcycle 290. The sliders have been raised to lift the motorcycle 290 into the elevated position. Optionally, slider detainers 160 may be used to lock sliders 110 in position on slider guide 120. A second motorcycle 290 is shown positioned below the first motorcycle 290. Accordingly, in some embodiments, system 100 may be used to store one or more motorcycles 290 in a vertical position.

FIG. 39 illustrates a front-view of an embodiment of system 100. The embodiment of system 100 shown in FIG. 39 corresponds to an embodiment of system 100 as shown in FIG. 36 except with slider 110 being operably coupled to a yoke 150 that is configured to be inserted into a motorcycle hub. The embodiment shown in FIG. 39 includes a base plate 230 that is operably coupled to two slider guides 120. The embodiment shown in FIG. 39 includes a stabilizer 300 that is operably coupled to two slider guides 120.

FIG. 40 illustrates a rear-view of an embodiment of system 100. The embodiment of system 100 shown in FIG. 40 corresponds to an embodiment of system 100 as shown in FIG. 39. In FIG. 40, a first motorcycle 290 is shown coupled to system 100 and held in an elevated position. In this instance, one yoke 150 of system 100 has been inserted into a front hub of motorcycle 290 and a second yoke 150 of system 100 has been inserted into a rear hub of motorcycle 290. The sliders 110 have been raised to lift the motorcycle 290 into the elevated position. Optionally, slider detainers 160 may be used to lock sliders 110 in position on slider guide 120. A second motorcycle 290 is shown positioned below the first motorcycle 290. Accordingly, in some embodiments, system 100 may be used to store one or more motorcycles 290 in a vertical position.

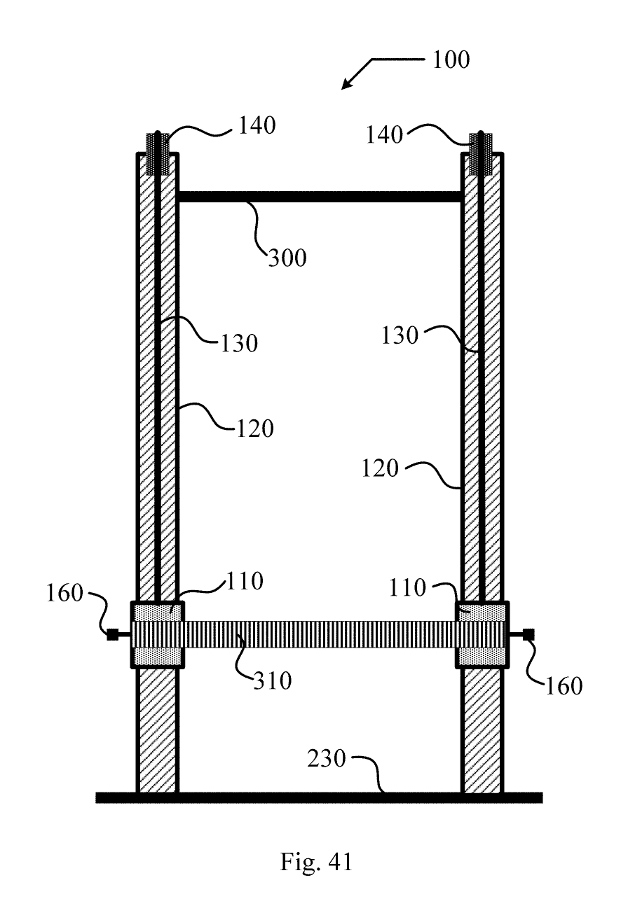

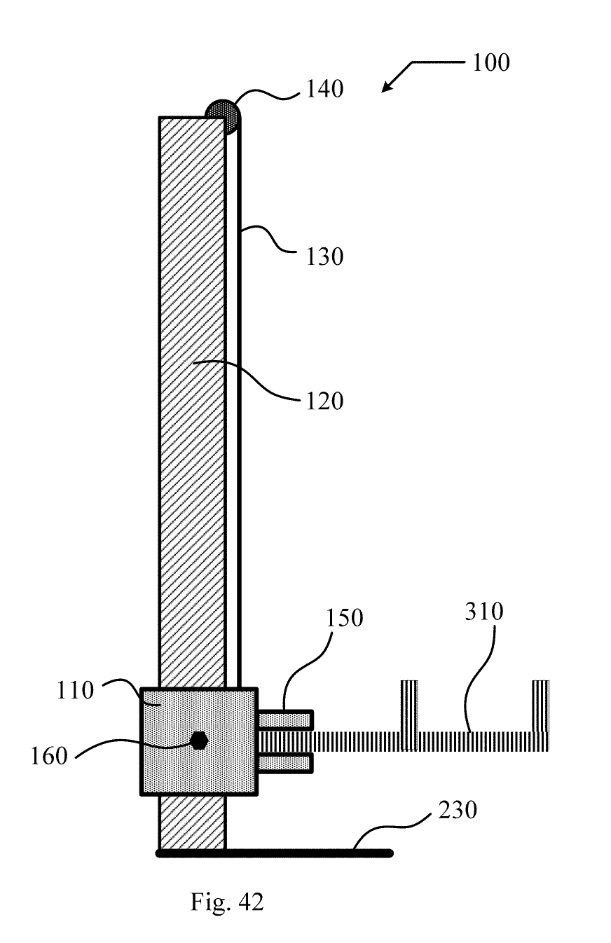

FIG. 41 illustrates a front-view of an embodiment of system 100. Sliders 110 are shown as being operably coupled to slider guides 120 with sliders 110 being positioned at a lower position relative to slider guides 120. In this embodiment, sliders 110 are shown as encircling slider guides 120 with a slider guide 120 passing through the interior of each of sliders 110 (see, e.g., FIG. 47). Sliders 110 are shown as being operably coupled to optional slider detainers 160. In some embodiments, slider detainers 160 may be used to lock sliders 110 at numerous positions relative to slider guides 120. Sliders 110 are each operably coupled to a slider support 130. Slider supports 130 are shown as being operably coupled to an upper portion of each of sliders 110. Slider supports 130 are also shown as being operably coupled to rotatable members 140 such that slider supports 130 are able to travel over rotatable members 140 when sliders 110 are moved relative to slider supports 130 (see e.g., FIG. 2). In some embodiments, system 100 may include one or more weights 190 that are operably coupled to slider supports 130 and contained within the interior of slider supports 120 (not shown, see e.g., FIGS. 5-8). In some embodiments, system 100 may include one or more springs 240 that are operably coupled to slider supports 130 and contained within the interior of slider supports 120 (not shown, see e.g., FIGS. 22 and 23). In some embodiments, system 100 may include one or more winches 250 operably coupled to one or more slider supports 130. Sliders 110 are shown as being operably coupled to carrier 310. Each of slider guides 120 are shown as being operably coupled to base plate 230.

FIG. 42 illustrates a side-view of an embodiment of system 100. Slider 110 is shown as being operably coupled to slider guide 120 with slider 110 being positioned at a lower position relative to slider guide 120. In this embodiment, slider 110 is shown as encircling slider guide 120 with slider guide 120 passing through the interior of slider 110 (see, e.g., FIG. 47). Slider 110 is shown as being operably coupled to an optional slider detainer 160. In some embodiments, a slider detainer 160 may be used to lock slider 110 at numerous positions relative to slider guide 120. Slider 110 is operably coupled to slider support 130. Slider support 130 is shown as being operably coupled to an upper portion of slider 110. Slider support 130 is shown as being operably coupled to rotatable member 140 such that slider support 130 is able to travel over rotatable member 140 when slider 110 is moved relative to slider support 130 (see e.g., FIG. 2). In some embodiments, system 100 may include one or more weights 190 that are operably coupled to a slider support 130 and contained within the interior of slider support 120 (not shown, see e.g., FIGS. 5-8). In some embodiments, system 100 may include one or more springs 240 that are operably coupled to one or more slider supports 130 and contained within the interior of a slider support 120 (not shown, see e.g., FIGS. 22 and 23). In some embodiments, system 100 may include one or more winches 250 operably coupled to one or more slider supports 130. Slider 110 is shown as being operably coupled to carrier 310 through a female yoke 150 that is operably coupled to slider 110. Slider guide 120 is shown as being operably coupled to base plate 230.

FIG. 43 illustrates a rear-view of an embodiment of system 100. The embodiment of system 100 shown in FIG. 43 corresponds to an embodiment of system 100 as shown in FIG. 41. In FIG. 43, a first motorcycle 290 is shown coupled to system 100 and held in an elevated position. In this instance, the first motorcycle 290 has been loaded onto carrier 310. The sliders have been raised to lift the motorcycle 290 into the elevated position. Optionally, slider detainers 160 may be used to lock motorcycle 290 in position on slider guide 120. A second motorcycle 290 is shown that is positioned below the first motorcycle 290. Accordingly, in some embodiments, system 100 may be used to store one or more motorcycles 290 in a vertical position.

FIG. 44 illustrates a side-view of an embodiment of system 100. Slider 110 is shown as being operably coupled to slider guide 120 with slider 110 being positioned in a lowered position relative to slider guide 120. In this embodiment, slider 110 is shown as encircling slider guide 120 with slider guide 120 passing through the interior of slider 110 (see, e.g., FIG. 47). Slider 110 is operably coupled to slider support 130. Slider support 130 is shown as being operably coupled to upper and lower portions of slider 110. Slider support 130 is also shown as being operably coupled to rotatable members 140 such that slider support 130 is able to travel over rotatable members 140 when slider 110 is moved relative to slider support 130 (see e.g., FIG. 19). In some embodiments, system 100 may include a weight 190 that is operably coupled to slider support 130 and contained within the interior of slider support 120 (not shown, see e.g., FIGS. 16 and 17). In some embodiments, system 100 may not include a weight 190. In some embodiments, system 100 may include one or more springs 240 that are operably coupled to one or more slider supports 130 and contained within the interior or on the exterior of a slider support 120 (not shown, see e.g., FIGS. 22 and 23). In some embodiments, system 100 may include one or more winches 250 operably coupled to one or more slider supports 130 (not shown). Slider 110 is shown as being operably coupled to yoke 150. Yoke 150 is illustrated as a male yoke 150 in FIG. 44. Slider 110 is shown as optionally including slider detainer 160. In some embodiments, slider detainer 160 may be configured to reversibly lock slider 110 onto slider support 120 at numerous positions relative to slider guide 120. Slider guide 120 is shown as being operably coupled to base plate 230. Base plate 230 is also shown as being operably coupled with wheels 390. A tensioner 380 is shown as being operably coupled to rotating member 140. In some embodiments, tensioner 380 may be adjusted to provide increased resistance or decreased resistance to rotation by rotating member 140. A bicycle rack 320 is shown reversibly operably coupled to male yoke 150.

FIG. 45 illustrates a side-view of an embodiment of system 100. The embodiment of system 100 shown in FIG. 45 corresponds to an embodiment of system 100 as shown in FIG. 44 except that tensioner 380 is shown as being operably coupled to slider 110 in FIG. 45. Accordingly, in some embodiments, tensioner 380 may be adjusted to increase or decrease resistance of motion of slider 110 alone slider guide 120. For example, in some embodiments, a tensioner may be configured as a friction plate that contacts slider guide 120. In some embodiments, a tensioner may be configured as an adjustable clamp that contacts slider guide 120.

FIG. 46 illustrates a side-view of an embodiment of system 100. The embodiment of system 100 shown in FIG. 46 corresponds to an embodiment of system 100 as shown in FIG. 44 except that tensioner 380 is not shown FIG. 46. In addition, bicycle rack 320 as shown in FIG. 44 is replaced by platform 330 in FIG. 46. In some embodiments, platform 330 may be configured as a shelf, basket, tray, and the like. Carrier 330 is shown as being operably coupled to male yoke 150.

FIG. 47 illustrates a cross-sectional transverse view of an embodiment of system 100. Slider guide 120 is shown as a substantially rectangular tube. Slider 110 is shown as being a substantially rectangular tube. Slider 110 is shown as encircling slider guide 120 with slider guide 120 passing through the interior of slider 110 such that slider 110 is free to move on slider guide 120. Yoke 150 is shown as being coupled to slider 110.

FIG. 48 illustrates a cross-sectional transverse view of an embodiment of system 100. Slider guide 120 is shown as being a substantially rectangular tube. In this embodiment, slider 110 is shown as being substantially rectangular. Slider 110 is included within the interior of slider guide 120 with yoke 150 passing through a channel in slider guide 120.

FIG. 49 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130. Slider support 130 is shown as being operably coupled to a weight 190 that is on the exterior of slider support 120. Slider support 120 is shown as being operably coupled to base plate 230.

FIG. 50 illustrates a cross-sectional transverse view of an embodiment of system 100. Slider guide 120 is shown as being a substantially rectangular tube. In this embodiment, slider 110 is shown as being substantially rectangular. Slider 110 is included within the interior of slider guide 120 with yoke 150 passing through a channel in slider guide 120. A plurality of bearings 340 are shown as being operably coupled to slider 100. Accordingly, in some embodiments, bearings 340 may contact the interior of slider guide 120.

FIG. 51 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 is operably coupled to a plurality of bearings 340. Accordingly, in some embodiments, bearings 340 contact the interior surfaces of slider guide 120. Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130. Slider support 130 is shown as being operably coupled to a weight 190 that is positioned on the exterior of slider support 120. Slider support 120 is shown as being operably coupled to base plate 230.

FIG. 52 illustrates a cross-sectional transverse view of an embodiment of system 100. Slider guide 120 is shown as being a substantially rectangular tube having two compartments. In this embodiment, slider 110 is shown as being substantially rectangular. Slider 110 is included within the interior of a first compartment of slider guide 120 with yoke 150 passing through a channel in slider guide 120. Weight 190 is shown as being contained within the second compartment of slider guide 120.

FIG. 53 illustrates a longitudinal cross-sectional view of an embodiment of system 100. In this embodiment, slider 110 is shown as being included within an interior compartment of slider guide 120 with yoke 150 passing through a channel in slider guide 120 (not shown, see e.g., FIG. 48). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130. Slider support 130 is shown as being operably coupled to a weight 190 that is positioned within an interior compartment of slider support 120. Slider support 120 is shown as being operably coupled to base plate 230.

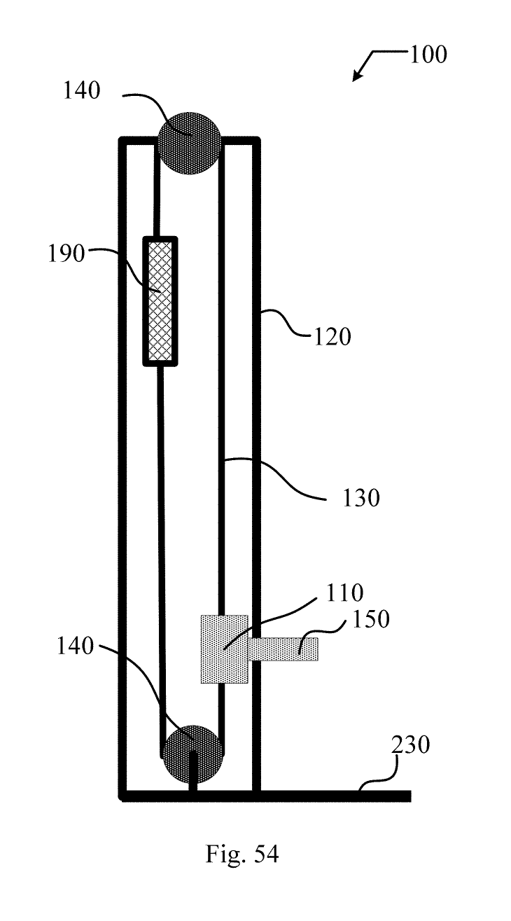

FIG. 54 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 is operably coupled to slider support 130. Slider support 130 is shown as being operably coupled to upper and lower portions of slider 110. Slider support 130 is also shown as being operably coupled to rotatable members 140 such that slider support 130 is able to travel over rotatable members 140 when slider 110 is moved relative to slider support 130. Slider support 130 is shown as being operably coupled to a weight 190 that is positioned within the interior of slider support 120. In some embodiments, system 100 may not include weight 190. Slider support 120 is shown as being operably coupled to base plate 230.

FIG. 55 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 is operably coupled to slider stabilizer 350. Slider stabilizer 350 is shown as passing through a passage through the interior of slider 110. Slider stabilizer 350 is operably coupled to slider guide 120. Slider 110 is operably coupled to slider support 130. Slider support 130 is shown as being operably coupled to an upper portion of slider 110. Slider support 130 is also shown as being operably coupled to a rotatable member 140 such that slider support 130 is able to travel over rotatable member 140 when slider 110 is moved relative to slider support 130. Slider support 130 is shown as being operably coupled to a weight 190 that is positioned within the interior of slider support 120. Slider support 120 is shown as being operably coupled to base plate 230.

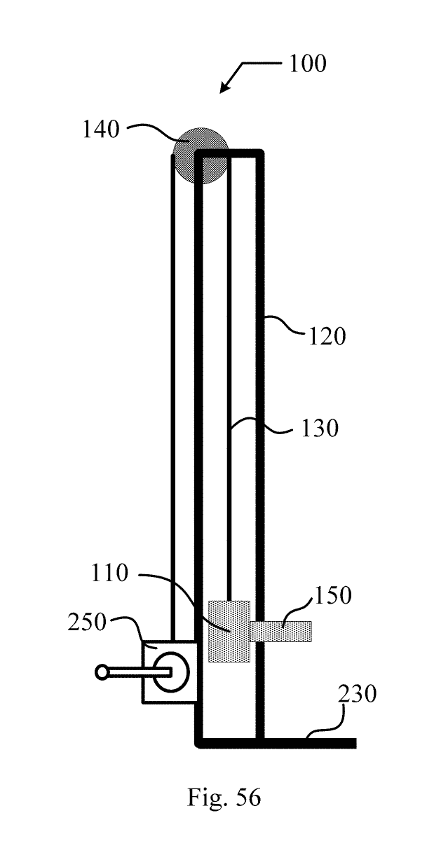

FIG. 56 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130. Slider support 130 is shown as being operably coupled to a mechanical winch 250 that is positioned on the exterior of slider support 120. Slider support 120 is shown as being operably coupled to base plate 230.

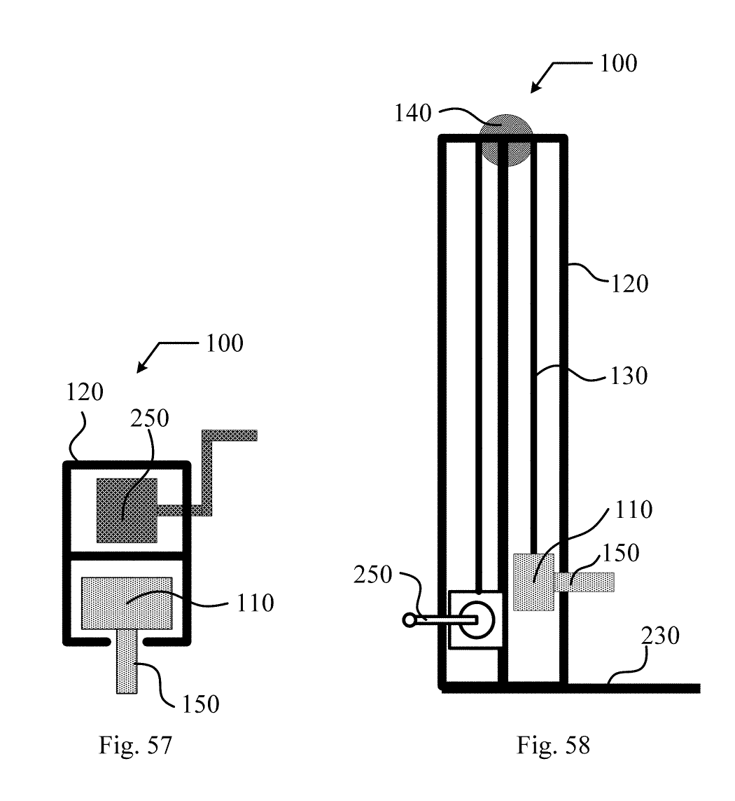

FIG. 57 illustrates a cross-sectional transverse view of an embodiment of system 100. Slider guide 120 is shown as being a substantially rectangular tube having two compartments. In this embodiment, slider 110 is shown as being substantially rectangular. Slider 110 is included within the interior of a first compartment of slider guide 120 with yoke 150 passing through a channel in slider guide 120. Winch 250 is shown as being contained within the second compartment of slider guide 120.

FIG. 58 illustrates a longitudinal cross-sectional view of an embodiment of system 100. In this embodiment, slider 110 is shown as being included within an interior compartment of slider guide 120 with yoke 150 passing through a channel in slider guide 120 (not shown, see e.g., FIG. 57). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130. Slider support 130 is shown as being operably coupled to a mechanical winch 250 that is positioned within an interior compartment of slider support 120. Slider support 120 is shown as being operably coupled to base plate 230.

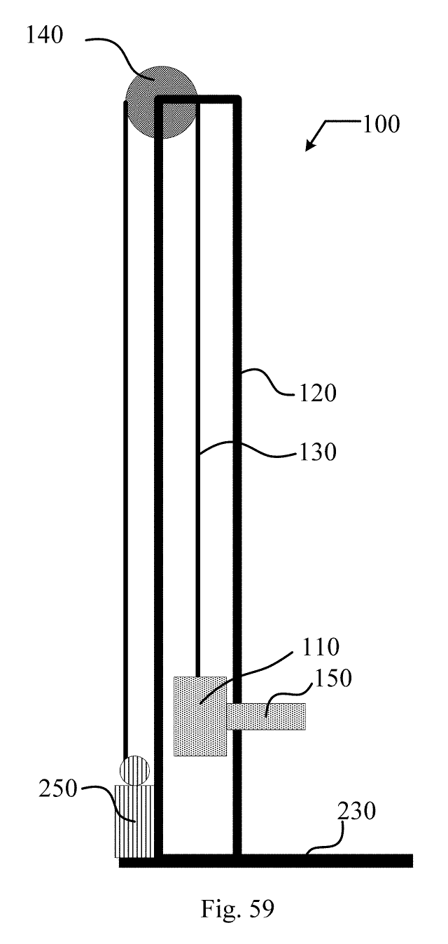

FIG. 59 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 57). Slider 110 is operably coupled to slider support 130. Slider support 130 is shown as being operably coupled to an upper portion of slider 110. Slider support 130 is also shown as being operably coupled to rotatable member 140 such that slider support 130 is able to travel over rotatable member 140 when slider 110 is moved relative to slider support 130. Slider support 130 is shown as being operably coupled to an electric winch 250 that is positioned on the exterior of slider support 120. Slider support 120 is shown as being operably coupled to base plate 230.

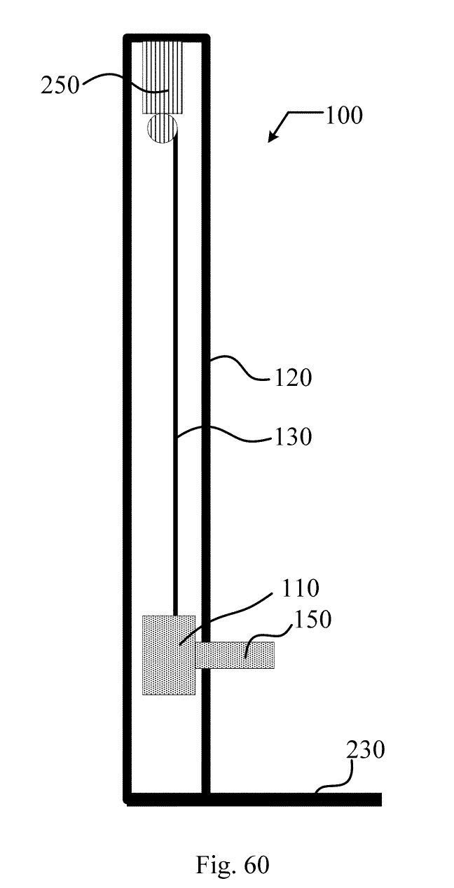

FIG. 60 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 is operably coupled to slider support 130. Slider support 130 is shown as being operably coupled to an upper portion of slider 110. Slider support 130 is shown as being operably coupled to an electric winch 250 that is operably coupled within the interior of slider guide 120. Slider guide 120 is shown as being operably coupled to base plate 230.

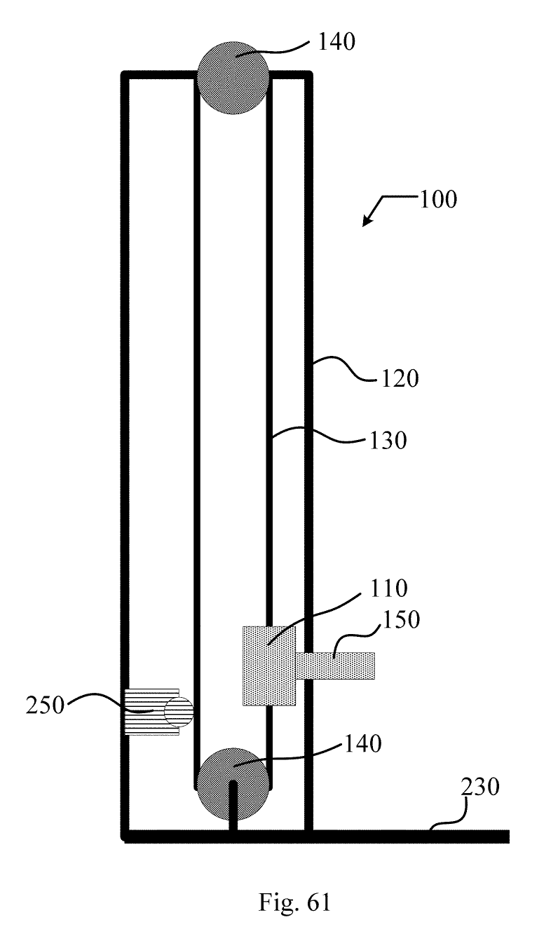

FIG. 61 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 is operably coupled to slider support 130. Slider support 130 is shown as being operably coupled to upper and lower portions of slider 110. Slider support 130 is also shown as being operably coupled to rotatable members 140 such that slider support 130 is able to travel over rotatable members 140 when slider 110 is moved relative to slider support 130. Slider support 130 is shown as being operably coupled to electric winch 250 that is positioned within the interior of slider guide 120. Slider guide 120 is shown as being operably coupled to base plate 230.

FIG. 62 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 is operably coupled to slider stabilizer 350. Slider stabilizer 350 is shown as passing through a passage through the interior of slider 110. Slider stabilizer 350 is operably coupled to slider guide 120. Slider 110 is operably coupled to slider support 130. Slider support 130 is shown as being operably coupled to an upper portion of slider 110. Slider support 130 is also shown as being operably coupled to a rotatable member 140 such that slider support 130 is able to travel over rotatable member 140 when slider 110 is moved relative to slider support 130. Slider support 130 is shown as being operably coupled to an electric winch 250 that is positioned within the interior of slider support 120. Slider support 120 is shown as being operably coupled to base plate 230.

FIG. 63 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 includes a threaded passage through which threaded member 370 passes. Accordingly, rotation of threaded member 370 causes slider 110 to move within slider guide 120. Threaded member 370 is operably coupled to slider guide 120. Threaded member 370 is also operably coupled to motor 360. Motor 360 is shown as being operably coupled with base plate 230 in this embodiment. Accordingly, in some embodiments, the position of slider 120 may be controlled through operation of motor 360 that rotates threaded member 370. Slider support 120 is shown as being operably coupled to base plate 230.

FIG. 64 illustrates a longitudinal cross-sectional view of an embodiment of system 100. In this embodiment, slider 110 is shown as being included within the interior of slider guide 120 with yoke 150 passing through a channel in slider guide 120 (not shown, see e.g., FIG. 48). Slider 110 includes a threaded passage through which threaded member 370 passes. Accordingly, rotation of threaded member 370 causes slider 110 to move within slider guide 120. Threaded member 370 is operably coupled to slider guide 120. Threaded member 370 is also operably coupled to motor 360. Motor 360 is shown as being operably coupled with an upper portion of slider guide 120 in this embodiment. Accordingly, in some embodiments, the position of slider 120 may be controlled through operation of motor 360 that rotates threaded member 370. Slider support 120 is shown as being operably coupled to base plate 230.

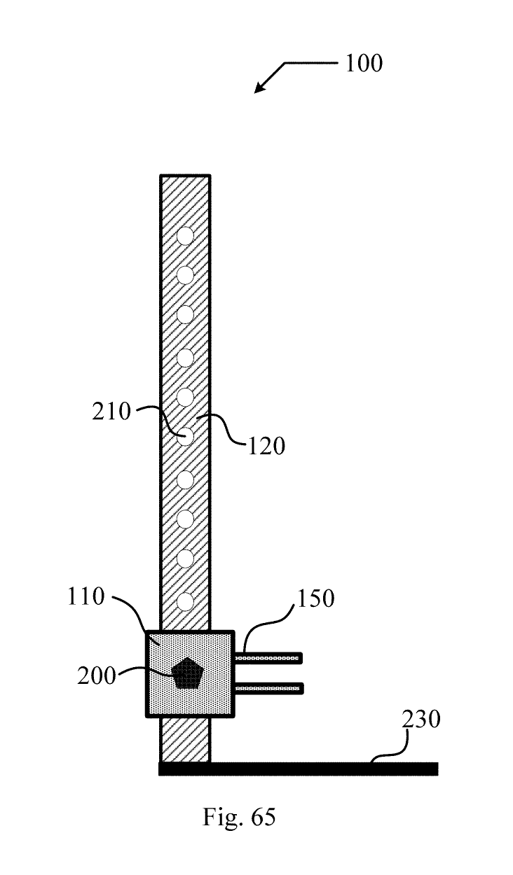

FIG. 65 illustrates a side-view of an embodiment of system 100. Slider 110 is shown as being operably coupled to yoke 150 that is configured as a female yoke 150. FIG. 65 also shows slider 110 as being operably coupled to retainer pin 200 and a series of retainer pin receivers 210 positioned at various positions on slider guide 120. In some embodiments, retainer pin 200 may be configured to be received by a retainer pin receiver 210. Accordingly, in some embodiments, slider 110 may be secured at various positions along slider guide 120 through insertion of retainer pin 200 into retainer pin receiver 210. In some embodiments, retainer pin 200 and retainer pin receivers 210 may be replaced by slider detainer 160 that is configured to lock slider 110 in numerous positions on slider guide 120.

FIG. 66 illustrates a longitudinal cross-sectional view of an embodiment of system 100. In this embodiment, slider 110 is shown as being included within the interior of slider guide 120 with yoke 150 passing through a channel in slider guide 120 (see e.g., FIG. 57). Slider 110 is operably coupled to rotatable member 140 that is configured as a pulley. Slider support 130 is shown as being operably coupled to three rotatable members 140. Slider support 130 is shown as being operably coupled to three rotatable members 140 such that slider support 130 is able to travel over rotatable members 140 when slider 110 is moved relative to slider support 130. Slider support 130 is shown as being operably coupled to cleat 400 that is positioned on the exterior of slider support 120. Slider support 120 is shown as being operably coupled to base plate 230.

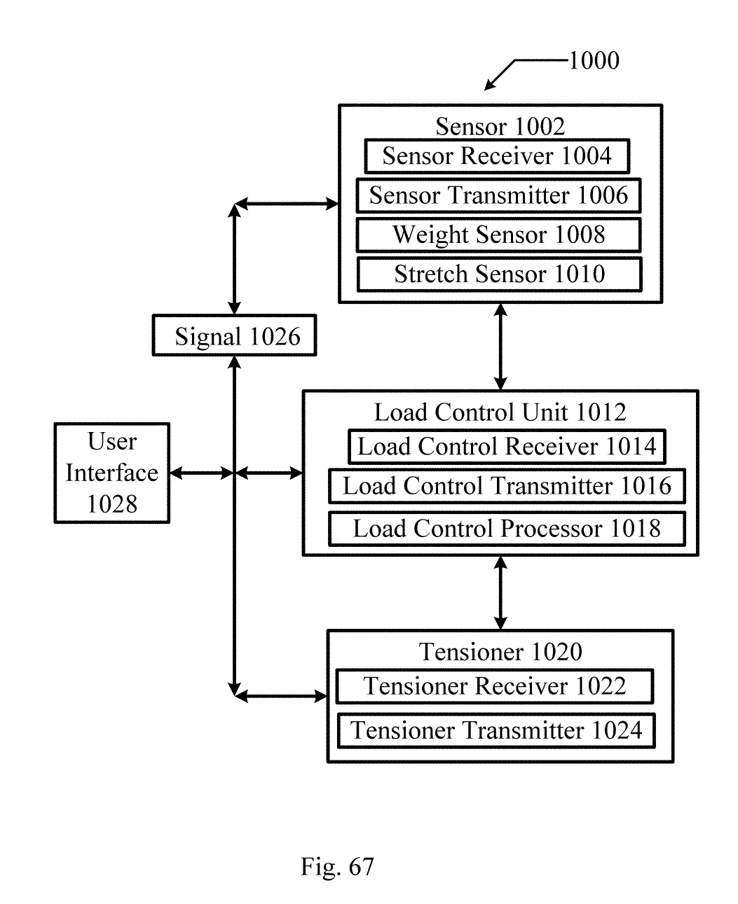

FIG. 67 illustrates a system diagram of an embodiment of system 1000 in which embodiments may be implemented. As illustrated, system 1000 may include sensor 1002, load control unit 1012, tensioner 1020, signal 1026, and user interface 1028.

System 1000 is illustrated as including sensor 1002. In some embodiments, sensor 1002 may include a sensor receiver 1004. In some embodiments, sensor 1002 may include a sensor transmitter 1006. Accordingly, in some embodiments, sensor 1002 may transmit and/or receive one or more signals 1026. In some embodiments, sensor 1002 may include one or more weight sensors 1008 configured to detect a load applied to slider 110. For example, in some embodiments, sensor 1002 may include one or more weight sensors 1008 that are configured as a scale to detect a load applied to slider 110. In some embodiments, sensor 1002 may include one or more weight sensors 1008 that are configured as a stretch sensor 1010 to detect stretch of a slider support 130 operably coupled to slider 110 in order to determine a load applied to slider 110. Accordingly, system 1000 may include numerous types of sensors 1002 and sensor related circuitry.

System 1000 is illustrated as including a load control unit 1012. In some embodiments, load control unit 1012 may include a load control receiver 1014. In some embodiments, load control unit 1012 may include a load control transmitter 1016. Accordingly, in some embodiments, load control unit 1012 may transmit and/or receive one or more signals 1026. In some embodiments, load control unit 1012 may include a load control processor 1018. In some embodiments, a load control processor 1018 may receive a signal 1026 from sensor 1002 indicating a load applied to slider 110 and determine an amount of resistance that should be applied by tensioner 1020 to counterbalance the load applied to slider 110. For example, in some embodiments, a load control unit 1012 may receive a signal 1026 indicating that a load of 60 pounds has been applied to slider 110 in a system that includes a weight 190 that is 100 pounds. Accordingly, in some embodiments, the load control unit 1012 may determine that tensioner 1020 should be adjusted to apply 40 pounds of resistance to counterbalance the load applied to slider 110. In some embodiments, load control unit 1012 may transmit one or more signals 1026 instructing tensioner 1020 to apply a determined amount of resistance.

System 1000 is illustrated as including signal 1026. Numerous types of signals may be transmitted and received within system 1000. Examples of such signals include, but are not limited to, wireless signals, hardwired signals, infrared signals, and the like.

System 1000 is illustrated as including tensioner 1020. In some embodiments, tensioner 1020 may include a tensioner receiver 1022. In some embodiments, tensioner 1020 may include a tensioner transmitter 1024. Accordingly, in some embodiments, tensioner 1020 may transmit and/or receive one or more signals 1026. In some embodiments, tensioner 1020 may receive a signal 1026 from load control unit 1012 indicating resistance to be applied to counterbalance a load applied to slider 110. For example, in some embodiments, a load control unit 1012 may transmit a signal 1026 indicating that tensioner 1020 should be adjusted to apply 40 pounds of resistance to counterbalance a load applied to slider 110. Numerous types of tensioners may be used within system 1000. For example, in some embodiments, tensioner 1020 may include a clamp that is operably coupled to a slider and that controllably clamps onto slider support 130. In some embodiments, a tensioner may include a clamp that is operably coupled to an axil of rotatable member 140 and that may engage the axil to regulate the resistance with which rotatable member 140 rotates. Accordingly, tensioner 1020 may be configured in numerous ways.

System 1000 is illustrated as including user interface 1028. In some embodiments, user interface 1028 may include interface receiver 1030. In some embodiments, user interface 1028 may include interface transmitter 1032. Accordingly, in some embodiments, user interface 1028 may transmit and/or receive one or more signals 1026. In some embodiments, user interface 1028 may include interface processor 1034. Accordingly, in some embodiments, user interface 1028 may receive signal 1026 that includes information, process the information, and then transmits signal 1026 that includes processed information. For example, in some embodiments, user interface 1028 may receive one or more signals 1026 from one or more sensors 1002 that include information related to a load applied to slider 110. User interface 1028 may process the information and determine an amount of resistance to be applied by tensioner 1020. User interface 1028 may then transmit one or more signals 1026 that include instructions for tensioner 1020 to apply the amount of resistance. Accordingly, in some embodiments, user interface 1028 may receive one or more signals 1026 from sensor 1002, load control unit 1012, tensioner 1020, mobile interface 1036, or substantially any combination thereof. In some embodiments, user interface 1028 may transmit one or more signals 1026 to sensor 1002, load control unit 1012, tensioner 1020, mobile interface 1036, or substantially any combination thereof. User interface 1028 may be configured in numerous ways. For example, in some embodiments, a user interface may include a touch screen, a keypad, a toggle switch, a mobile interface 1036, and the like. Accordingly, in some embodiments, user interface 1028 may be used in conjunction with a mobile device such as a cellular telephone, a digital assistant, the internet, and the like.

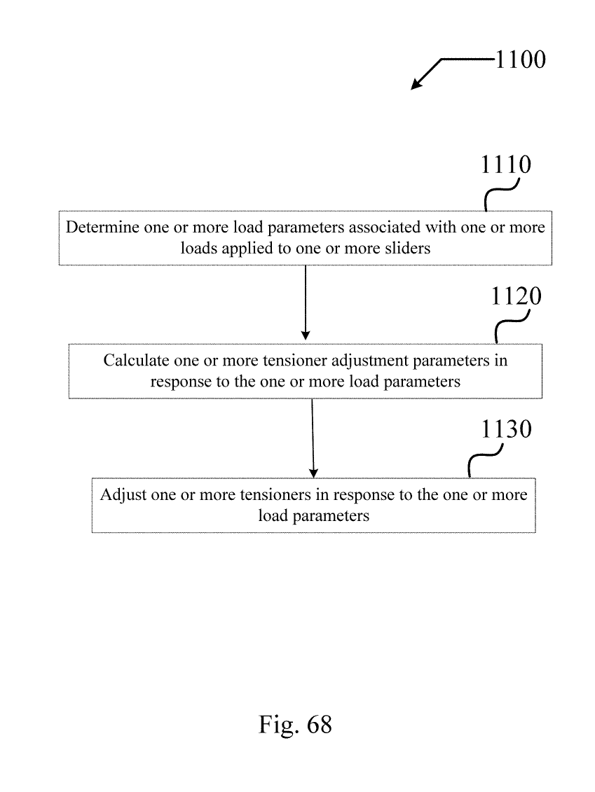

FIG. 68 illustrates an operational flow diagram 1100 of an embodiment that may be utilized within system 100 and within system 1000 in which embodiments may be implemented. In some embodiments, operational flow 1100 may include determining one or more load parameters associated with one or more loads applied to one or more sliders and transmitting one or more signals that indicate the one or more load parameters; receiving the one or more signals that indicate the one or more load parameters, calculating one or more tensioner adjustment parameters in response to the one or more load parameters, and transmitting one or more signals that indicate the one or more tensioner adjustment parameters; and receiving the one or more signals that indicate the one or more tensioner adjustment parameters and adjusting one or more tensioners in response to the one or more tensioner adjustment parameters.

Operation 1110 may include, but is not limited to, determining one or more load parameters associated with one or more loads applied to one or more sliders and transmitting one or more signals that indicate the one or more load parameters. In some embodiments, one or more sensors may determine one or more load parameters associated with one or more loads applied to one or more sliders and transmit one or more signals that indicate the one or more load parameters.

In some embodiments, a sensor may determine the weight of a load applied to a slider. A sensor may be configured to determine the weight of a load in numerous ways. For example, in some embodiments, a sensor may be configured to determine how much a slider support stretches in response to a load being applied to a slider. In some embodiments, a sensor may be configured as a spring that stretches in response to a load applied to a slider 110. In some embodiments, a sensor may measure the compression of a spring that is responsive to a load applied to a slider 110. Accordingly, a sensor may be configured in numerous ways to determine the weight of a load that is applied to a slider 110.

In some embodiments, a sensor may be configured to determine the position of a load applied to a slider 110. For example, in some embodiments, a sensor may include a laser that is configured to beam light in one or more positions to determine the position of a load applied to a slider 110. In some embodiments, a sensor may be configured to determine the position of a slider 110 relative to a slider support in order to determine the position of a load that is applied to the slider 110. Accordingly, a sensor may be configured in numerous ways to determine the position of a load that is applied to a slider 110.

In some embodiments, a sensor may transmit one or more signals that indicate the one or more load parameters. In some embodiments, such signals may be received by one or more load control units. In some embodiments, such signals may be received by one or more user interfaces.

Operation 1120 may include, but is not limited to, receiving one or more signals that indicate one or more load parameters, calculate one or more tensioner adjustment parameters in response to the one or more load parameters, and transmitting one or more signals that indicate the one or more tensioner adjustment parameters. In some embodiments, load control unit and/or user interface may receive one or more signals that indicate one or more load parameters, calculate one or more tensioner adjustment parameters in response to the one or more load parameters, and transmit one or more signals that indicate the one or more tensioner adjustment parameters.

Load control unit and/or user interface may use numerous methods to calculate one or more tensioner parameters in response to one or more load parameters. For example, in some embodiments, a load parameter that includes the weight of a load applied to a slider 110 may be compared to the weight of weight 190 included with system 1000. The difference in the weight of the load and the weight of weight 190 may be determined and the tensioner adjustment parameter may be calculated to balance the weight of the load with the weight of weight 190. For example, in some embodiments, if a 60 pound load is applied to a slider 110 within system 1000 and the weight of weight 190 within system 1000 is 100 pounds, the difference will be 40 pounds. Accordingly, a tensioner adjustment parameter may be calculated to apply a force to equalize the difference of 40 pounds. In some embodiments, the weight of a load applied to slider 110 within system 1000 may be compared to a spring constant of a spring included within system 1000. The difference between the weight of the load and the spring constant may be used to calculate a tensioner adjustment parameter. Accordingly, numerous methods may be used to calculate a tensioner adjustment parameter.

Operation 1130 may include, but is not limited to, receiving one or more signals that indicate one or more tensioner adjustment parameters and adjusting resistance of one or more tensioners in response to the one or more tensioner adjustment parameters. In some embodiments, one or more tensioners may receive one or more signals that indicate one or more tensioner adjustment parameters and adjust resistance of the one or more tensioners in response to the one or more tensioner adjustment parameters.

Tensioner may use numerous methods to adjust resistance of tensioner. For example, in some embodiments, tensioner may include a clamp that is operably coupled to slider and to slider guide. Accordingly, the force with which the clamp engages the slider guide may be adjusted in accordance with the tensioner adjustment parameter. In some embodiments, tensioner may include a clamp that engages an axle that is operably coupled to a rotatable member such that increasing clamping force of the clamp will increase resistance to movement of the rotatable member. In some embodiments, a tensioner may be operably coupled to a slider and include one or more friction plates that engage a slider guide such that increasing the force with which the one or more friction plates engage the slider guide will increase resistance to movement of the slider on the slider guide. Accordingly, in some embodiments, a tensioner may include a mechanism, such as an electric motor, that is operable to control a clamp and/or a friction plate.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

Those skilled in the art will recognize that the methods and systems of the present disclosure may be implemented in many manners and as such are not to be limited by the foregoing exemplary embodiments and examples. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, a myriad of combinations are possible in achieving the functions, features, interfaces and preferences described herein. Moreover, the scope of the present disclosure covers conventionally known manners for carrying out the described features and functions and interfaces, as well as those variations and modifications that may be made to the components described herein as would be understood by those skilled in the art now and hereafter.

While various embodiments have been described for purposes of this disclosure, such embodiments should not be deemed to limit the teaching of this disclosure to those embodiments. Various changes and modifications may be made to the elements and operations described above to obtain a result that remains within the scope of this disclosure.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

All publications, patents and patent applications cited herein are incorporated herein by reference. The foregoing specification has been described in relation to certain embodiments thereof, and many details have been set forth for purposes of illustration, however, it will be apparent to those skilled in the art that the invention is susceptible to additional embodiments and that certain of the details described herein may be varied considerably without departing from the basic principles of the invention.

What is claimed is:

1. A device comprising:
at least one slider guide;
at least one slider moveably coupled to the at least one slider guide;
at least one yoke operably coupled to the at least one slider;
at least one slider support operably coupled to the at least one slider; and
at least one rotatable member operably coupled to the at least one slider support and the at least one slider guide.

2. The device of claim 1, further comprising:
at least one spring operably coupled to the at least one slider support.

3. The device of claim 1, further comprising:
at least one weight operably coupled to the at least one slider support.

4. The device of claim 1, further comprising:
at least one winch operably coupled to the at least one slider support and to the at least one slider guide.

5. The device of claim 1, further comprising:
at least one bracket operably coupled to the at least one slider guide.

6. The device of claim 1, further comprising:
at least one base plate operably coupled to the at least one slider guide.

7. The device of claim 1, further comprising:
at least one hanger operably coupled to the at least one slider guide.

8. The device of claim 1, wherein the at least one slider is moveably coupled within the interior of the at least one slider guide and the at least one yoke protrudes through at least one channel disposed within the at least one slider guide.

9. The device of claim 1, wherein the at least one slider guide is contained within the interior of the at least one slider moveably coupled to the at least one slider guide.

10. The device of claim 1, wherein the at least one yoke comprises:
at least one female yoke.

11. The device of claim 1, wherein the at least one yoke comprises:
at least one male yoke.

12. The device of claim 1, wherein the at least one yoke comprises:
at least one yoke configured to couple with a motorcycle hub.

13. The device of claim 1, further comprising:
at least one stabilizer operably coupled to at least one slider guide.

14. A device comprising:
at least one slider guide;
at least one slider moveably coupled to the at least one slider guide;
at least one yoke operably coupled to the at least one slider;
at least one slider support operably coupled to the at least one slider; and
at least one winch operably coupled to the at least one slider support.

15. The device of claim 14, further comprising:
at least one base plate operably coupled to the at least one slider guide.

16. The device of claim 14, further comprising:
at least one bracket operably coupled to the at least one slider guide.

17. A device comprising:
at least one slider guide;
at least one slider moveably coupled to the at least one slider guide;
at least one yoke operably coupled to the at least one slider;
at least one threaded member threadedly coupled to the at least one slider.

18. The device of claim 17, further comprising:
at least one motor operably coupled to the at least one threaded member.

19. The device of claim 17, wherein the at least one slider is moveably coupled within the interior of the at least one slider guide, the at least one yoke protrudes through at least one channel disposed within the at least one slider guide, the at least one threaded member and the at least one motor are contained within the interior of the at least one slider guide.

20. The device of claim 17, wherein the at least one slider guide is contained within the interior of the at least one slider moveably coupled to the at least one slider guide, and the at least one threaded member and the at least one motor are contained on the exterior of the at least one slider guide.
